(19) United States
(12) Patent Application Publication
(10) Pub. No.: US 2026/0330314 A1
(43) Pub. Date: Oct. 22, 2026

(54) INTERACTIVE COMMUNICATION QUALITY CONTROL, FEEDBACK, AND TRAINING

(71) Applicant: Foundever Operating Corporation, Miami, FL (US)

(72) Inventors: Guillaume H. Laporte, Barcelona (ES); Nicolas Lellouche, Barcelona (ES); Jay Srinivasan, Odessa, TX (US); Maria J. Marenco Rodriguez, Managua (NI); Osvaldo Zamora Sotolongo, Miami, FL (US); Kishore Allanki, Hyderabad (IN); Musheer A. Abdul Qaiyum, Pune (IN); Mounika Kancharla, Bentonville, AR (US); Aadil Shaikh, Thane (IN); Wasim A. Qureshi, Mumbai (IN); Vadym Shestopalov, Barcelona (ES); Krishna Chaitanya Gadhiraju, Hyderabad (IN); Rebecca Jonsson, Barcelona (ES); Ameer Janjua, Aurora, CO (US); Ricardo Solis Ramirez, Heredia (CR); Francisco Cucullu, Barcelona (ES); Alienor M.S. Dartiguenave, Paris (FR); Jan Leyva Massague, Barcelona (ES); Marko A. Prokic, Belgrade (RS); Ravi Shankar Bharti, Patna (IN)

(73) Assignee: Foundever Operating Corporation, Miami, FL (US)

(21) Appl. No.: 19/643,000

(22) Filed: Apr. 9, 2026

Related U.S. Application Data
(60) Provisional application No. 63/790,990, filed on Apr. 18, 2025.

(51) Int. Cl. G06N 20/00

(52) U.S. Cl. CPC G06N 20/00

(57) ABSTRACT

A system for monitoring interactive communications, automatically evaluating communication quality, and generating customized training modules. The system ingests call recordings between agents and end users from a centralized data repository, converts the recordings into speaker-diarized transcripts using language-specific speech recognition, and redacts payment card industry data during transcription. The system segments transcripts and evaluates agent performance attributes using large language models. An automated quality control module processes each transcript through an evaluation pipeline that applies a large language model to evaluate the transcript against custom quality forms comprising evaluation questions, scoring rules, and descriptive elements configured per account, generating quality scores at scale. A scheduler operates daily processing pipelines tied to specific project identifications. A calibration module enables users to adapt evaluation parameters and manually edit scoring to maintain human oversight. The system aggregates performance data to generate personalized training modules delivered to agents.

### TECHNICAL FIELD AND BACKGROUND

This invention relates generally to systems for monitoring, evaluating, and enhancing interactive communication quality.

Traditional approaches to interactive communication monitoring and quality assurance rely on manual review of a limited sample of interactive communication instances between enterprise agents and outside users. These manual processes are time-intensive, subjective, inconsistent, and inherently limited in the scope and number of interactions that can be analyzed. This limited scope leaves significant gaps in quality monitoring and reduces the accuracy and usefulness of evaluations.

What is needed are systems and methods that provide automated, customized interactive communication quality analysis, feedback, and system training across wide swaths of enterprise interactive communications. It is, therefore, an object of the present disclosure to provide systems that conduct automated and detailed analyses of large volumes of interactive communications across an enterprise to develop customizable, executable feedback and training modules. The systems and methods utilize artificial intelligence (“AI”) and natural language processing (“NLP”) technologies to implement an automated quality assurance module (“AutoQA”) that processes interactive communications and that uses generative AI to produce objective, comprehensive quality evaluations at scale, thereby enhancing the precision of feedback and broadening the scope of evaluated interactions beyond what manual review can achieve.

### SUMMARY

The present technology relates to systems and methods for monitoring agent performance during interactive communication sessions, which are also called “shared experiences,” and developing a customized training plan. The system processes recorded calls or written communications between a customer service agent and an end user (i.e., a customer) to measure agent performance and provide a customized training plan. The training plans, which are also called “action plans,” are customized to individual agents and include suggestions for improvement and a quality analysis. The systems and methods combine automatic speech recognition (“ASR”) (also known as speech-to-text or “STT”), machine learning, deep learning, and large language models (“LLMs”) into a single cohesive system for complete agent performance management.

The system first collects content data from verbal and written customer service interactions handled by human customer service agents. The content data can be in any format including, audio signals or alphanumeric text. For voice calls, the content data is first captured and stored as audio signals embodied in audio data. The system uses speech recognition technology to convert the audio signal to alphanumeric text data.

The system performs diarization operations to identify the participant, or content source, for each unit of linguistic expression or “speech” within the content data. That is, each question, statement, or other utterance is labeled as associated with a particular participant (i.e., which participant is the customer and which is the agent). In one embodiment, the system first utilizes audio components of content data to detect the number of participants represented within content data. The system associates particular portions of the content data to particular participants. The system can then utilize linguistic elements of the content data to identify the participants. For instance, participants are identified by phrase frequency (e.g., phrases an agent is more likely to say, such as “How can I assist you?”) and phrases a customer is more likely to say, such as, “I need help.”

The system utilizes trained LLMs with tailored instructions (i.e., input prompts) to convert the content data into a segmented structure based on the flow or steps in a shared experience, such as an opening segment, a problem description, probing questions, explanation, solution discussion, and a closing segment. Segmenting the content data allows the system to analyze specific parts of a shared experience and assess the agent's behavior in context. For each segment, the system evaluates various attributes that are indicators of the agent's performance (e.g., probing, conversation control, explanation, following procedure). The number, types, names, and attributes that identify a segment are customizable according customer instructions, quality assurance guidelines, and agent training guidelines. In addition to segments, the instructed, trained LLMs can also identify substructures within the content data as part of detecting sentiment or detecting content data representing the performance of particular tasks, such as the communication of available transaction terms.

The system also uses trained, instructed LLMs to analyze the language in the interaction segments while accounting for nuances such as tone, sentiment, and effectiveness in communications. LLMs can also detect patterns in agent behavior, such as repeated use of certain phrases and frequency in which they interrupt customers. After analyzing each segment, the system can also analyze the overall shared experience to evaluate certain attributes applicable to the entire shared experience, such as politeness, sentiment, and consistency. The content data representing the shared experience is then labeled according to these attributes to enhance the ability to later search and reference shared experiences.

The system is also configured to generate summarization data using the content data where the summarization includes information such as the interaction driver (i.e., reason why the shared experience was initiated) and the outcome of a shared experience. In another aspect of the system, an Autofail detection module identifies portions of content data that represent a shared experience failure, such as a severe protocol deviation by an enterprise agent. A shared experience identified by the Autofail module may result in a customized training module being delivered to the agent, automated notice to a supervising agent, and removal of the shared experience content data from a corpus of data that is analyzed to detect system trends or set system policies.

After analyzing multiple shared experiences, the system aggregates the performance data to identify trended behaviors and attributes that are key indicators of an agent's performance. In this way, the system can track improvements or deteriorations in specific areas (e.g., probing, conversation control, explanation, following procedure) and identify recurring patterns that may indicate areas for improvement. For instance, if an agent consistently struggles with explanation, the system can flag this as a behavior trend and suggest areas of focus for future coaching. The system uses machine learning to identify if certain attributes are fulfilled in each segment of the shared experience. The system also uses machine learning to classify the whole shared experience according to defined attributes.

The system is configured to automatically generate a personalized training plan for the agent based on identified trends. The personalized training plan will propose clear instructions for the agent to improve their performance in future calls. The personalized action plan will also include excerpts to specific examples of shared experiences to exemplify the identified behavior. The personalized training plan is crafted using generative AI models that synthesize insights from analysis of agent performance.

According to one embodiment, a system for communication quality comprises a processor, a storage device storing data and executable code. When the code is executed, it causes the processor to capture interactive communications and store the interactive communications to the storage device as a content file. The content file is converted to machine encoded communication elements. When the code is executed, it also causes the processor to execute a diarization module that determines a source that generated each machine encoded communication element. The source may be an agent or an external user. Each content file is parsed into a plurality of segments. An interactive communication evaluation is generated by analyzing the machine encoded communication elements in each segment to detect the presence or absence of each attribute in an attribute set. This step may be performed by a large language model that may evaluate the machine encoded communication elements according to nuance attributes comprising tone, sentiment, communication efficacy, or interactive communication control. A training module is generated based on the interactive communication evaluation. The training module includes a set of executable instructions and is transmitted to an agent computing device. The agent computing device displays the customized training module on a display device integrated with an agent computing device, and the agent executes the set of executable instructions. The training module may include audio data and visual data that simulates a shared experience. The training module may also include a series of questions and selectable input functions displayed on the integrated display device.

The system may further include an automated quality control software module comprising executable code that, when executed, cause the processor to evaluate the machine encoded content elements generated by the agent by applying a quality form. The quality form includes a plurality of queries, and the automated quality control software module generates a response to each query. The system may further include a plurality of integration architectures to capture an interactive content file. The plurality of integration architectures may include native cloud integration, direct cloud storage integration, and file-based ingestion.

According to another embodiment, a system for communication quality comprises a processor, a storage device storing data and executable code. When the code is executed, it causes the processor to activate a digital recorder that captures interactive communications and stores the interactive communications to the storage device as a content file. The content file is converted to machine encoded communication elements. Sources to interactive communications are identified. The sources may include an agent. The agent may generate a set of machine encoded communication elements. The machine encoded content elements generated by the agent are analyzed to assess an agent's performance based on defined attributes. Additionally, each attribute in the attribute set may be assigned a score. Each attribute may include one or more of probing, clarity and structure, interactive communication control, process compliance, or tool usage. Each attribute may also include one or more of a handle time, a first call resolution, and a satisfaction score. A customized training module is generated for the agent based on the agent performance. The training module may include a set of executable instructions. The training module is transmitted to an agent computing device. The agent computing device may display the customized training module on a display device integrated with the agent computing device and the agent may execute the set of executable instructions.

The system may also include automated quality control software module with executable code. When the code is executed, it may cause the processor to evaluate the machine encoded content elements generated by the agent by applying a quality form. The quality form may include a plurality of queries, and the automated quality control software module may generate a response to each query. Additionally, when the code is executed, it may cause the processor to generate a quality form including a grid of evaluation queries and executable scoring instructions for each evaluation query; evaluate the machine encoded content elements generated by the agent by running a large language model software application that implements the quality form and generates a quality score; and store the quality score to the storage device in a format that is accessible to a user through a graphical user interface. The automated quality control software module may include a large language module. The quality form may be customizable and generated by a system user inputting natural language data into a graphical user interface.

According to another embodiment, a system for communication quality comprises a processor, a storage device storing data and executable code. When the code is executed, it causes the processor to interface with an external system that includes an interactive communication content file in a native format. The interactive communication content file is ingested to a DataLake.

The DataLake detects personal identifying information (“PII data”) as well as payment card information (“PCI data”) within the interactive communication content file and redacts PII data and PCI data from the interactive communication content file. The system may further include a plurality of integration architectures for ingesting the interactive communication content file, that includes native cloud integration, direct cloud storage integration, and file-based ingestion. The interactive communication content file is converted to machine encoded communication elements. The machine encoded communication elements are grouped according to a source, including an agent or an external user. Each interactive communication content file is parsed into a plurality of segments that each include the machine encoded content elements. An interactive communication evaluation is generated by analyzing the machine encoded communication elements in each segment according to an attribute set. Generating an interactive communication evaluation may be performed by a large language model. A training module is generated based on the interactive communication evaluation. The training module includes a set of executable instructions. The training module is transmitted to an agent computing device and the agent executes the set of executable instructions.

Additionally, when executed, the executable code further causes the processor to impose role-based access control. For example, the agent can access the interactive communication evaluation only if the agent is assigned a given role and the system can segregate data by a client account.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### DESCRIPTION OF THE FIGURES

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 illustrates an enterprise system, and environment according to an embodiment of the present invention;

FIG. 2A is a diagram of a feedforward network, according to at least one embodiment, utilized in machine learning;

FIG. 2B is a diagram of a convolution neural network, according to at least one embodiment, utilized in machine learning;

FIG. 2C is a diagram of a portion of the convolution neural network of FIG. 2B, according to at least one embodiment, illustrating assigned weights at connections or neurons;

FIG. 3 is a diagram representing an exemplary weighted sum computation in a node in an artificial neural network;

FIG. 4 is a diagram of a Recurrent Neural Network (“RNN”), according to at least one embodiment, utilized in machine learning;

FIG. 5 is a schematic logic diagram of an artificial intelligence program including a front-end and a back-end algorithm;

FIG. 6 is a flow chart representing a method, according to at least one embodiment, of model development and deployment by machine learning;

FIG. 7 is an example data flow diagram illustrating the ingestion, processing, redaction, and evaluation of interactive communication data through the automated quality assurance system;

FIG. 8 illustrates an example system architecture for a system that performs interactive communication monitoring and training module generation;

FIG. 9A is a portion of an example process flow for interactive communication analysis, segmentation, and behavior trend identification;

FIG. 9B is a portion of an example process flow for interactive communication analysis, segmentation, and behavior trend identification;

FIG. 10 depicts an example graphical user interface for displaying agent performance metrics and a customized training plan;

FIG. 11 depicts an example graphical user interface for displaying a customized training plan;

FIG. 12 illustrates the architecture of EverCoach application.

FIG. 13 illustrates an example system architecture for an automated quality assurance system that is integrated with a centralized data repository and an AI coaching module.

### DETAILED DESCRIPTION

The disclosed novel systems and methods utilize AI technology to automate the quality assurance and performance monitoring for how enterprise agents engage in interactive communication sessions with outside users, such as customers. The systems provide personalized feedback, executable performance plans, and training modules for enterprise agents.

Traditional systems and methods for quality assurance review only one to three percent of interactive communication sessions between agents and customers, which does not provide a full picture of performance. Such systems also rely on standardized training materials and methods that do not apply to many agents and that do not focus on subject matter where improvement is most needed. As a result an enterprise is not able to generate strong training plans that are targeted to individual agents. When feedback and training are not meeting agent needs, the agents become less engaged and are unable to meet performance targets, which leads to higher absenteeism and turnover.

Traditional systems also utilize a large number of interfaces and software tools that lead to inefficiencies and confusion. The manual review and use of disparate interfaces often means that performance feedback and training is delayed, which allows inefficient and ineffective actions to continue for long periods of time before being addressed. The resulting impacts include inefficient use of system resources and lower quality interactive communications between customer service agents and enterprise customers.

The present systems and methods includes an automated quality assurance module (“AutoQA”) that processes interactive communications using generative AI to produce objective, comprehensive quality evaluations at scale. The result is an enhanced precision of feedback and a broadened scope of evaluated interactions beyond what manual review can achieve. The system further creates customized training modules, or “action plans,” for execution by system users to enhance efficiency and improve customer experience.

The present systems and methods address the drawbacks of traditional systems by providing technology that (i) can analyze interactive communications at scale leading to up to 100% coverage instead of 1% to 3%; (ii) automate monotonous and repetitive tasks to reduce manual workload; (iii) reduce time spent on each evaluation by up to 38%; (iv) eliminate human subjective scoring inconsistencies and bias; (v) centralize interactions and insights; (vi) allow enterprise personnel to focus on coaching and training instead of evaluations; (vii) offer multilingual training capabilities. The benefits include, without limitation, enabling an enterprise to: (i) identify gaps in agent training and performance; (ii) increase the quality of interactive communications; (iii) increase compliance with customer requirements for interactive communications, such as the required recitation of particular prompts; (iv) increase sales; (v) reduce penalties for noncompliance; (vi) reduce the time required for enterprise agents to achieve proficiency.

### Interpreting the Specification

Aspects of the present invention and certain features, advantages, and details thereof are explained more fully below with reference to the non-limiting examples illustrated in the accompanying drawings. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure.

Unless described or implied as exclusive alternatives, features throughout the drawings and descriptions should be taken as cumulative, such that features expressly associated with some particular embodiments can be combined with other embodiments. Illustrative embodiments are described below using specific, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof. Various changes, combinations, omissions, modifications and substitutions, in addition to those set forth in the above paragraphs, are possible.

Aspects of the present invention are described herein with reference to flowchart illustrations and/or block diagrams of computer-implemented methods and computing systems according to embodiments of the invention. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus. Each block in the flowchart/diagrams may represent a module, segment, or portion of instructions, comprising one or more executable instructions for implementing the specified logical function(s).

A processor may execute the computer readable program instructions thereby creating a means for implementing the actions specified in the flowchart illustrations and/or block diagrams. Computer program implemented steps or acts may be combined with operator or human implemented steps or acts in order to carry out an embodiment of the invention. The functions noted in the blocks may occur out of the order noted in the Figures. For example, two blocks shown in succession may, in fact, be executed substantially concurrently, or the blocks may sometimes be executed in the reverse order, depending upon the functionality involved.

These computer readable program instructions may also be stored in a computer readable storage medium that can direct a processor to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

Computer program instructions are configured to carry out operations of the present invention and may be or may incorporate assembler instructions, instruction-set-architecture (“ISA”) instructions, machine instructions, machine dependent instructions, microcode, firmware instructions, state-setting data, source code, and/or object code written in any combination of one or more programming languages.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended and describe one or more steps or elements possessing those one or more steps or elements, but is not limited to possessing only those one or more steps or elements.

It will be understood that relative terms are intended to encompass different orientations or sequences in addition to the orientations and sequences depicted in the drawings and described herein. Relative terminology, such as “substantially” or “about,” describe the specified devices, materials, transmissions, steps, parameters, or ranges as well as those that do not materially affect the basic and novel characteristics of the claimed inventions as a whole (as would be appreciated by one of ordinary skill in the art).

The terms “coupled,” “fixed,” “attached to,” “communicatively coupled to,” “operatively coupled to,” and the like refer to both: (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

As used herein, the term “provider” generally describes the person or entity providing services, such as customer support and can be used interchangeably with the term “enterprise.” The term “customer support” is used interchangeably with the terms support, customer service, customer interaction, interactive communication, interactive communication session or instance, or a “shared experience.” Customer support generally includes, but is not limited to, providing customers with assistance in utilizing existing products and services and with purchasing additional products and services. Shared experiences result in the generation of interactive content data, interactive communication data, or simply “content data,” through the exchange of verbal or written communications and expressions of ideas that are converted to, and stored as, interactive content data files.

The term “client” is used to generally denote a separate business entity from the service provider. Customers of the client are provided support by the service provider on behalf of the client; in other words, the provider is operating as a third-party provider of customer support services for the client. The term “agent” generally describes an individual who interfaces with the customer to provide customer support using the systems and methods described herein, and the term is used interchangeably with the terms end user, user, associate, or representative.

The term “user” is used interchangeably with the terms end user, customer or consumer and represents individuals to whom a provider is rendering goods or services or individuals, with whom the provider has an ongoing relationship, and who contact a provider by telephone, video chat, email, text, or an instant message software application to request assistance with provider products and services. The term “participants” is used interchangeably with the term “content sources” and refers to humans or automated software technology (e.g., a chat bot) that generate linguistic expressions of ideas that can be processed using artificial intelligence and natural language processing technologies. For instance, content sources can include an agent and a customer or end user generating interactive content data as part of a shared experience.

The term “content” is used to generally refer to alphanumeric text, audio data, or video data in digital form and can be used interchangeably with the terms interactive content data, audio data, audio signals, video data, video signals, alphanumeric content data, alphanumeric text data, and text data. Content data can take various forms depending on whether a shared experience occurring using video conferencing software, a telephone, email, or instant chat messaging. These terms for content can be used interchangeably with the term “transcript data” where the terms are being used to refer to a written digital record, in text form, of a single speaker or a written or verbal interaction between multiple participants in a conversation or discussion. Content can be generated by transcribing an oral interaction during a shared experience by telephone or video conference, or generated during written exchanges by email, instant “chat” messaging, short message service (“SMS”), or messages exchanged through various online platforms or social media software applications.

### System Level Description

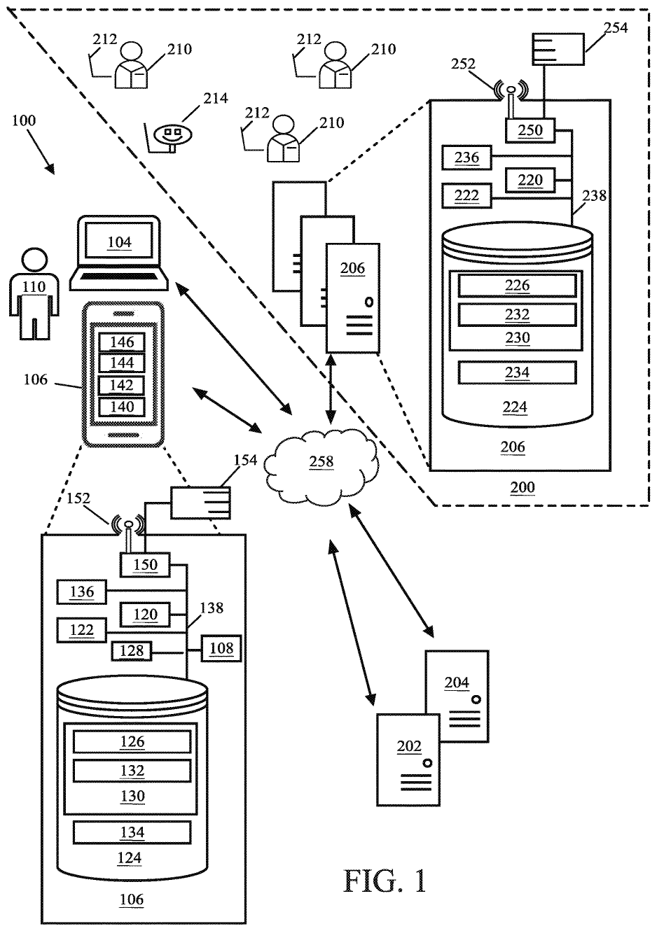

FIG. 1 illustrates an example system 100 according to at least one embodiment where a user 110 interfaces with an enterprise system 200. The environment includes, for example, a distributed cloud computing environment (private cloud, public cloud, community cloud, and/or hybrid cloud), an on-premise environment, fog computing environment, and/or an edge computing environment. The user 110 accesses the enterprise system 200 by use of one or more end user computing devices, such as a personal desktop computing device 104 or a mobile device 106, which may include a smart phone, a tablet computing device, or other types of portable devices with processing and communication capabilities.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of, or having access to, the user computing device, referring to either or both of the mobile device 106 and computing device 104, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (“RAM”), and read-only memory (“ROM”). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (“RAM”) including a cache area for the temporary storage of data. The memory device 122 may also include non-volatile memory, which can be embedded and/or may be removable. The non-volatile memory can additionally or alternatively include an electrically erasable programmable read-only memory (“EEPROM”), flash memory or the like.

According to various embodiments, the memory device 122 and storage device 124 may be combined into a single storage medium. The memory device 122 and storage device 124 can store any of a number of software applications which comprise computer-executable instructions and code executed by the processing device 120 to implement the functions of the mobile device 106 described herein. For example, the memory device 122 may include software applications such as a web browser application or a virtual telephone application. These software applications also typically provide a graphical user interface (“GUI”) on the display 140 that allows the user 110 to communicate with the mobile device 106 or other devices or systems.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem.

The processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (“WAP”), Hypertext Transfer Protocol (“HTTP”), and/or the like.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain.

The processing device 120 can be or can include, as non-limiting examples, a central processing unit (“CPU”), a microprocessor, a graphics processing unit (“GPU”), a microcontroller, an application-specific integrated circuit (“ASIC”), a programmable logic device (“PLD”), a digital signal processor (“DSP”), a field programmable gate array (“FPGA”), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120.

The input and output system 136 may also include a display 140 (e.g., a liquid crystal display (“LCD”), light emitting diode (“LED”) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action.

The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user.

Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (“GPS”) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. The positioning device 108 can include a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). The system intraconnect 138 may operatively couple various components with one another, or in other words, electrically connects those components, either directly or indirectly through intermediate components.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154.

Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, a Global Positioning System (“GPS”) may be included for navigation and location-related data exchanges, ingoing and/or outgoing. Communications may also or alternatively be conducted via the connector 154 for wired connections such as by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. The clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, customer support representatives, online customer service assistants available to users 110, advisors, managers, sales team members, and referral agents ready to route user requests and communications to preferred or particular other agents, human or virtual.

Human agents 210 may utilize agent computing devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent computing devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (“RAM”), and read-only memory (“ROM”). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subject matter of these descriptions pertain. The processing device 220 can be or can include, as non-limiting examples, a central processing unit (“CPU”), a microprocessor, a graphics processing unit (“GPU”), a microcontroller, an application-specific integrated circuit (“ASIC”), a programmable logic device (“PLD”), a digital signal processor (“DSP”), a field programmable gate array (“FPGA”), a state machine, a controller, gated or transistor logic, discrete physical hardware components, and combinations thereof.

Furthermore, the computing system 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet.

A portion of the network 258 may be a virtual private network (“VPN”) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated system 100. The network 258 may communicate, for example, Internet Protocol (“IP”) packets, Frame Relay frames, Asynchronous Transfer Mode (“ATM”) cells, voice, video, data, and other suitable information between network addresses. The network 258 may also include one or more local area networks (“LANs”), radio access networks (“RANs”), metropolitan area networks (“MANs”), wide area networks (“WANs”), all or a portion of the internet and/or any other communication system or systems at one or more locations.

The network 258 may incorporate a cloud platform/data center that support various service models including Platform as a Service (“PaaS”), Infrastructure-as-a-Service (“IaaS”), and Software-as-a-Service (“SaaS”). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, client systems, government entities, clubs, and groups of any size are all within the scope of the descriptions. In at least one example, the external systems 202 and 204 represent merchant and/or client systems configured to interact with the user device 106 during transactions and also configured to interact with the enterprise system 200 in back-end transactions.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

### Artificial Intelligence Technology

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (“AI”) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subject matters of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (“KNN”), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (“DBSCAN”), mean shift clustering, expectation maximization (“EM”) clustering using Gaussian mixture models (“GMM”), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

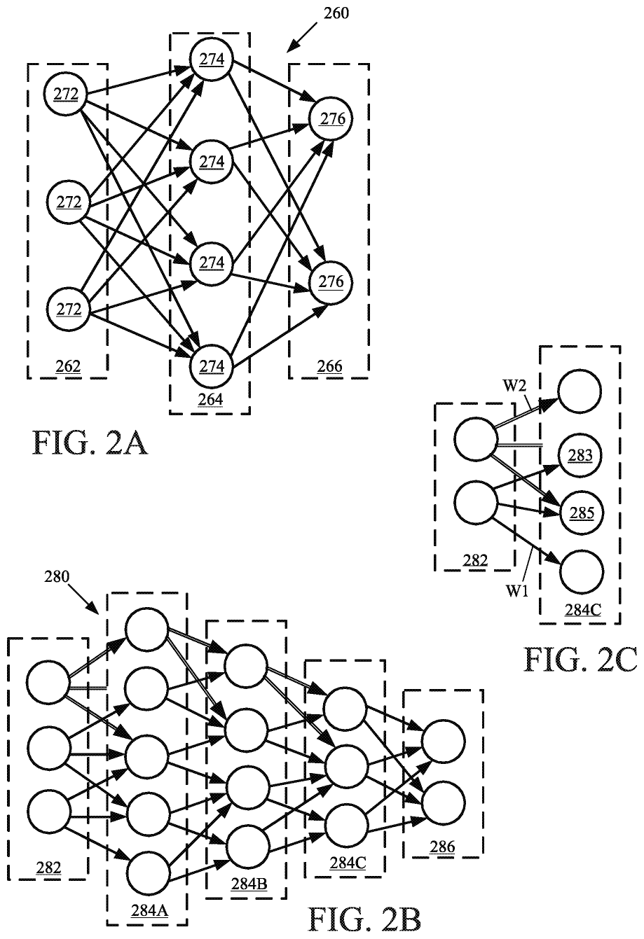

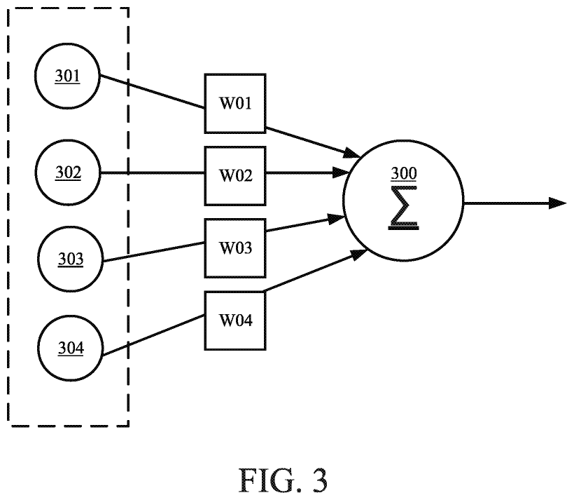

An artificial neural network (“ANN”), also known as a feedforward network, may be utilized, e.g., an acyclic graph with nodes arranged in layers. A feedforward network (see, e.g., feedforward network 260 referenced in FIG. 2A) may include a topography with a hidden layer 264 between an input layer 262 and an output layer 266. The input layer 262, having nodes commonly referenced in FIG. 2A as input nodes 272 for convenience, communicates input data, variables, matrices, or the like to the hidden layer 264, having nodes 274. The hidden layer 264 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 272 of the input layer, which then communicates the data to the hidden layer 264. The hidden layer 264 may be configured to determine the state of the nodes in the respective layers and assign weight coefficients or parameters of the nodes based on the edges separating each of the layers, e.g., an activation function implemented between the input data communicated from the input layer 262 and the output data communicated to the nodes 276 of the output layer 266. It should be appreciated that the form of the output from the neural network may generally depend on the type of model represented by the algorithm. Although the feedforward network 260 of FIG. 2A expressly includes a single hidden layer 264, other embodiments of feedforward networks within the scope of the descriptions can include any number of hidden layers. The hidden layers are intermediate the input and output layers and are generally where all or most of the computation is done.

An additional or alternative type of neural network suitable for use in the machine learning program and/or module is a Convolutional Neural Network (“CNN”). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An exemplary convolutional neural network CNN is depicted and referenced as 280 in FIG. 2B. As in the basic feedforward network 260 of FIG. 2A, the illustrated example of FIG. 2B has an input layer 282 and an output layer 286. However where a single hidden layer 264 is represented in FIG. 2A, multiple consecutive hidden layers 284A, 284B, and 284C are represented in FIG. 2B. The edge neurons represented by white-filled arrows highlight that hidden layer nodes can be connected locally, such that not all nodes of succeeding layers are connected by neurons. FIG. 2C, representing a portion of the convolutional neural network 280 of FIG. 2B, specifically portions of the input layer 282 and the first hidden layer 284A, illustrates that connections can be weighted. In the illustrated example, labels W1 and W2 refer to respective assigned weights for the referenced connections. Two hidden nodes 283 and 285 share the same set of weights W1 and W2 when connecting to two local patches.

Weight defines the impact a node in any given layer has on computations by a connected node in the next layer. FIG. 3 represents a particular node 300 in a hidden layer. The node 300 is connected to several nodes in the previous layer representing inputs to the node 300. The input nodes 301, 302, 303 and 304 are each assigned a respective weight W01, W02, W03, and W04 in the computation at the node 300, which in this example is a weighted sum.

An additional or alternative type of feedforward neural network suitable for use in the machine learning program and/or module is a Recurrent Neural Network (“RNN”). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter, e.g., at least a portion of the output data from the RNN may be used as feedback/input in calculating subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

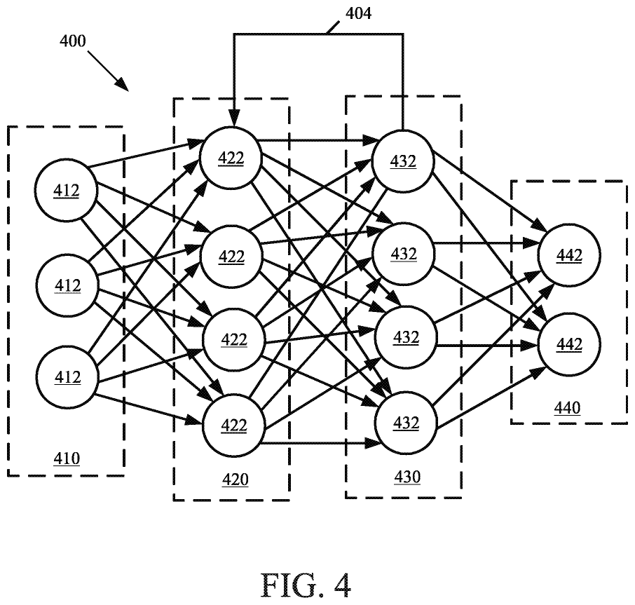

An example for a Recurrent Neural Network RNN is referenced as 400 in FIG. 4. As in the basic feedforward network 260 of FIG. 2A, the illustrated example of FIG. 4 has an input layer 410 (with nodes 412) and an output layer 440 (with nodes 442). However, where a single hidden layer 264 is represented in FIG. 2A, multiple consecutive hidden layers 420 and 430 are represented in FIG. 4 (with nodes 422 and nodes 432, respectively). As shown, the RNN 400 includes a feedback connector 404 configured to communicate parameter data from at least one node 432 from the second hidden layer 430 to at least one node 422 of the first hidden layer 420. It should be appreciated that two or more and up to all of the nodes of a subsequent layer may provide or communicate a parameter or other data to a previous layer of the RNN 400. Moreover and in some embodiments, the RNN 400 may include multiple feedback connectors 404 (e.g., connectors 404 suitable to communicatively couple pairs of nodes and/or connector systems 404 configured to provide communication between three or more nodes). Additionally or alternatively, the feedback connector 404 may communicatively couple two or more nodes having at least one hidden layer between them, i.e., nodes of nonsequential layers of the RNN 400.

In an additional or alternative embodiment, the machine-learning program may include one or more support vector machines. A support vector machine may be configured to determine a category to which input data belongs. For example, the machine-learning program may be configured to define a margin using a combination of two or more of the input variables and/or data points as support vectors to maximize the determined margin. Such a margin may generally correspond to a distance between the closest vectors that are classified differently. The machine-learning program may be configured to utilize a plurality of support vector machines to perform a single classification. For example, the machine-learning program may determine the category to which input data belongs using a first support vector determined from first and second data points/variables, and the machine-learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine-learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine-learning program may include a relatively large number of layers, e.g., three or more layers, and may be referred to as deep neural networks. For example, the node of each hidden layer of a neural network may be associated with an activation function utilized by the machine-learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input/output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (“RDBMS”) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

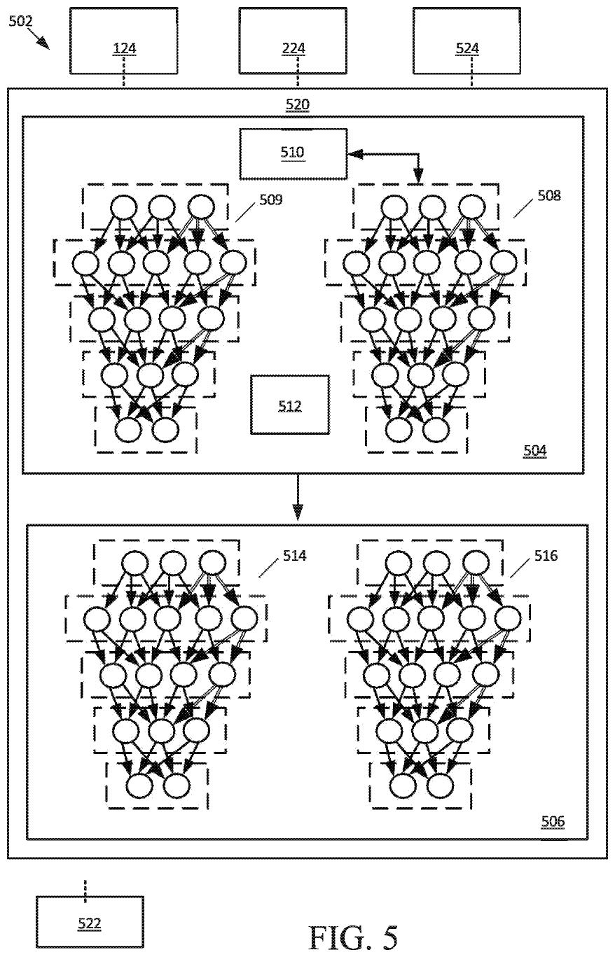

Referring now to FIG. 5 and some embodiments, an AI program 502 may include a front-end algorithm 504 and a back-end algorithm 506. The artificial intelligence program 502 may be implemented on an AI processor 520, such as the processing device 120, the processing device 220, and/or a dedicated processing device. The instructions associated with the front-end algorithm 504 and the back-end algorithm 506 may be stored in an associated memory device and/or storage device of the system (e.g., storage device 124, memory device 122, storage device 224, and/or memory device 222) communicatively coupled to the AI processor 520, as shown. Additionally or alternatively, the system may include one or more memory devices and/or storage devices (represented by memory 524 in FIG. 5) for processing use and/or including one or more instructions necessary for operation of the AI program 502. In some embodiments, the AI program 502 may include a deep neural network (e.g., a front-end algorithm 504 configured to perform preprocessing, such as feature recognition, and a back-end algorithm 506 configured to perform an operation on the data set communicated directly or indirectly to the back-end algorithm 506 that together form the deep neural network). For instance, the front-end algorithm 504 can include at least one CNN 508 communicatively coupled to send output data to the back-end algorithm 506.

Additionally or alternatively, the front-end algorithm 504 can include one or more AI algorithms 510, 512 (e.g., statistical models or machine learning programs such as decision tree learning, associate rule learning, recurrent artificial neural networks, support vector machines, and the like). In various embodiments, the front-end algorithm 504 may be configured to include built in training and inference logic or suitable software to train the neural network prior to use (e.g., machine learning logic including, but not limited to, image recognition, mapping and localization, autonomous navigation, speech synthesis, document imaging, or language translation such as natural language processing). For example, a CNN 508 and/or AI algorithm 510 may be used for image recognition, input categorization, and/or support vector training. In some embodiments and within the front-end algorithm 504, an output from an AI algorithm 510 may be communicated to a CNN 508 or 509, which processes the data before communicating an output from the CNN 508, 509 and/or the front-end algorithm 504 to the back-end algorithm 506. In various embodiments, the back-end algorithm 506 may be configured to implement input and/or model classification, speech recognition, translation, and the like. For instance, the back-end network 506 may include one or more CNNs (e.g., CNN 514) or dense networks (e.g., dense networks 516), as described herein.

For instance and in some embodiments of the AI program 502, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end algorithm 504). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 502 may be trained using a semi-supervised learning process in which some but not all of the output data is known, e.g., a mix of labeled and unlabeled data having the same distribution.

In some embodiments, the AI program 502 may be accelerated via a machine-learning framework 522 (e.g., hardware). The machine learning framework may include an index of basic operations, subroutines, and the like (primitives) typically implemented by AI and/or machine learning algorithms. Thus, the AI program 502 may be configured to utilize the primitives of the framework 522 to perform some or all of the calculations required by the AI program 502. Primitives suitable for inclusion in the machine learning framework 522 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine-learning program may include variations, adaptations, and alternatives suitable to perform the operations necessary for the system, and the present disclosure is equally applicable to such suitably configured machine learning and/or artificial intelligence programs, modules, etc. For instance, the machine-learning program may include one or more long short-term memory (“LSTM”) RNNs, convolutional deep belief networks, deep belief networks DBNs, and the like. DBNs, for instance, may be utilized to pre-train the weighted characteristics and/or parameters using an unsupervised learning process. Further, the machine-learning module may include one or more other machine learning tools (e.g., Logistic Regression (“LR”), Naive-Bayes, Random Forest (“RF”), matrix factorization, and support vector machines) in addition to, or as an alternative to, one or more neural networks, as described herein.

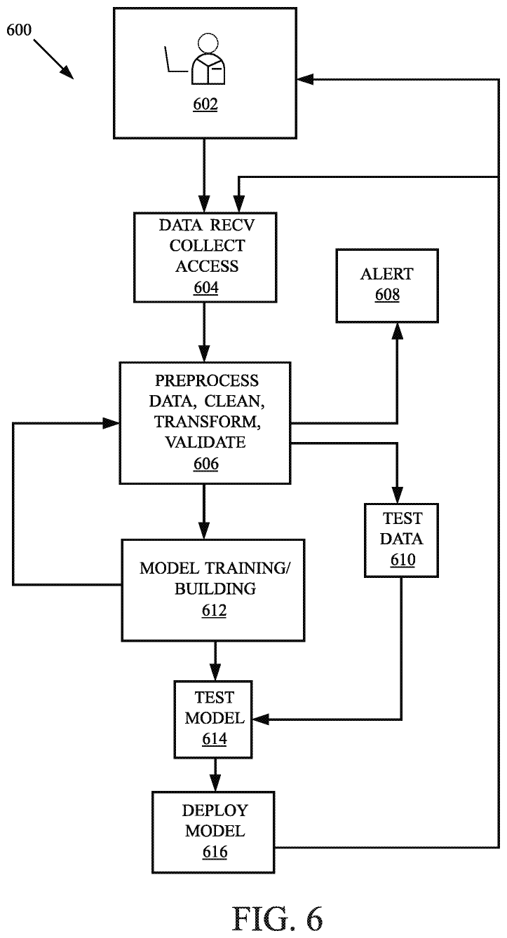

FIG. 6 is a flow chart representing a method 600, according to at least one embodiment, of model development and deployment by machine learning. The method 600 represents at least one example of a machine learning workflow in which steps are implemented in a machine-learning project.

In step 602, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, step 602 can represent a starting point. However, with regard to continuing or improving an ongoing machine learning workflow, step 602 can represent an opportunity for further user input or oversight via a feedback loop. Such feedback may flow through a user, or in various embodiments, the method automatically provides feedback, retrains and redeploys the retrained model.

In step 604, data is received, collected, accessed, or otherwise acquired and entered as can be termed data ingestion. In step 606, the data ingested in step 604 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing step 606 is updated with newly ingested data, an updated model will be generated. Step 606 can include data validation, which focuses on confirming that the statistics of the ingested data are as expected, such as that data values are within expected numerical ranges, that data sets are within any expected or required categories, and that data comply with any needed distributions such as within those categories. Step 606 can proceed to step 608 to automatically alert the initiating user, other human or virtual agents, and/or other systems, if any anomalies are detected in the data, thereby pausing or terminating the process flow until corrective action is taken.

In step 610, training test data such as a target variable value is inserted into an iterative training and testing loop. In step 612, model training, a core step of the machine learning work flow, is implemented. A model architecture is trained in the iterative training and testing loop. For example, features in the training test data are used to train the model based on weights and iterative calculations in which the target variable may be incorrectly predicted in an early iteration as determined by comparison in step 614, where the model is tested. Subsequent iterations of the model training in step 612 are conducted with updated weights in the calculations.

During each iteration of the training and testing loop, the accuracy of the model may be evaluated. In one embodiment, the re-evaluation of the model can include comparing an output of the model with an actual target result or variable to determine the accuracy of the prediction. If the model is not satisfying a minimum threshold level of accuracy (i.e., the model is underfitted), the system may automatically determine that the threshold level of accuracy is not satisfied and may adjust the weights for a subsequent iteration of the training and testing loop.

The weights may be iteratively adjusted during each iteration of the training and testing loop based on the comparison to the threshold level of accuracy. However, there is a balance for training the model in order to avoid overfitting when the model would not perform well on predictions of new data. Rather, the model is automatically trained to be well-fitted such that it satisfies a threshold level of accuracy without learning the noise in the data to the extent that the model would not apply to new data by preventing additional iterations of the training and testing once a maximum accuracy threshold value has been obtained. Thus, with each iteration of the training and testing loop, the accuracy of the model is improved and the iterative training and testing of the model provides an improvement to the performance of a computer and computing technology because the system may automatically determine how many iterations to perform so that the model is well-fitted by surpassing the minimum threshold level of accuracy while automatically stopping the iterative training and testing of the model before the maximum accuracy threshold is obtained.

In some embodiments, the training and testing loop utilizes a backpropagation algorithm and a gradient descent algorithm. Gradient descent is an optimization algorithm used to minimize differentiable real-valued multivariate functions. Gradient descent is an optimization algorithm used to minimize differentiable real-valued multivariate functions. The gradient descent algorithm may be used to iteratively adjust model parameters using calculated derivatives to minimize a loss function. Backpropagation may be used to calculate the gradient of the error function with respect to the neural network's weights.

When compliance and/or success in the model testing in step 614 is achieved, process flow proceeds to step 616, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

As discussed above, oversight of a deployed machine learning model may be automatically performed via a feedback loop whereby the method assesses performance of the deployed model (see step 616) and the feedback loop automatically provides feedback for further training of the machine learning model to improve its performance, and upon completion of the other method steps such as 612, the machine learning model that has been automatically retrained based on the feedback loop is then redeployed (step 614). In some embodiments, the system is continually receiving training data as new predictions are made and more data is collected. The continuous training data may be discretized to generate input data to retrain the model. Discretization methods can convert continuous data to discrete data by binning, clustering, and numerical discretization. The model may monitor incoming data sets to make predictions. When predictions are made, the system analyzes the predictions to determine whether the model needs to be retrained.

In some embodiments, the model may detect anomalies in the predictions. Anomaly detection can provide a benefit by identifying instances of the prediction that deviate from expected data or a general pattern. A difficulty in anomaly detection is that the system must define the boundary between ordinary data and anomalous data to accurately classify the data as ordinary or anomalous. The line between ordinary and anomalous may be difficult to determine with cases approaching a boundary and based on the specific application. For example, small variations may trigger an identification of an anomaly in the data while relatively larger deviations may be considered normal in less sensitive applications. The disclosed systems and methods may provide solutions to detecting anomalies in order to more accurately and quickly determine whether a model needs to be retrained. If data would be inapplicable or would corrupt the model by reducing the quality of the input data or training process (e.g., due to missing values, outliers, inconsistent formatting, incorrect labels, noisy data, etc.) that data may be automatically dropped and the source of that data may be blocked from providing data that would be used to train the model. This reflects an improvement in the process of training and deploying a model that is accurate and specific to the type of prediction sought. In particular, this provides an improvement in the field of model training, which provides a practical application.

In other applications, the anomaly detections processes described herein may be used to provide enhanced security to the overall computing system by detecting malicious attacks on network security. For example, the system may take proactive measures to remediate danger by detecting the source address associated with potentially malicious packets and dropping potentially malicious packets. This provides an improvement in network security by dropping potentially malicious packets and blocking future traffic from the source address of the potentially malicious source address.

### Natural Language Processing Technology

The systems and methods disclosed herein may also be used to analyze text to form the predictions. In particular, the systems and methods described herein include a combination of elements that are utilized in a specific manner for automatically performing automated processes based on technological efficiency, which provides a specific improvement over prior art systems resulting in improved computer processing for faster automated processing functions. For example, the systems and method may apply robotic process automation for digital transformation of the data based on specific criteria to interpret text and unstructured data using text processing software techniques. The interpretation of the text may be implemented using the models described herein including unsupervised learning techniques or supervised learning techniques. The processor may track how much memory and/or processing time has been allocated to perform a function and the system may be trained to automatically detect and identify processes eligible for increased efficiencies based on existing inefficiencies in the process.

For example, the machine learning models may use unsupervised learning to identify and characterize hidden structures of unstructured and unlabeled content data, or supervised techniques that operate on labeled content data and include instructions informing the system which outputs are related to specific input values. In such instances, software processing can rely on iterative training techniques and training data to configure neural networks with an understanding of individual words, phrases, subjects, sentiments, and parts of speech.

Supervised learning software systems are trained using content data that is labeled or “tagged.” During training, the supervised software systems learn the best mapping function between a known data input and expected known output (i.e., labeled or tagged content data). Supervised natural language processing software then uses the best approximating mapping learned during training to analyze unforeseen input data (never seen before) to accurately predict the corresponding output. Supervised learning software systems often require extensive and iterative optimization cycles to adjust the input-output mapping until they converge to an expected and well-accepted level of performance, such as an acceptable threshold error rate between a calculated probability and a desired threshold probability.

The software systems are supervised because the way of learning from training data mimics the same process of a teacher supervising the end-to-end learning process. Supervised learning software systems are typically capable of achieving excellent levels of performance, but this excellent level of performance requires labeled data to be available. Developing, scaling, deploying, and maintaining accurate supervised learning software systems can take significant time, resources, and technical expertise from a team of skilled data scientists. Moreover, precision of the systems is dependent on the availability of labeled content data for training that is comparable to the corpus of content data that the system will process in a production environment.

Supervised learning software systems implement techniques that include, without limitation, Latent Semantic Analysis (“LSA”), Probabilistic Latent Semantic Analysis (“PLSA”), Latent Dirichlet Allocation (“LDA”), and more recent Bidirectional Encoder Representations from Transformers (“BERT”). Latent Semantic Analysis software processing techniques process a corpus of content data files to ascertain statistical co-occurrences of words that appear together, which then give insights into the subjects of those words and documents.

Unsupervised learning software systems can perform training operations on unlabeled data and less requirement for time and expertise from trained data scientists. Unsupervised learning software systems can be designed with integrated intelligence and automation to automatically discover information, structure, and patterns from content data. Unsupervised learning software systems can be implemented with clustering software techniques that include, without limitation, K-means clustering, Mean-Shift clustering, Density-based clustering, Spectral clustering, Principal Component Analysis, and Neural Topic Modeling (“NTM”).

Clustering software techniques can automatically group semantically similar words together to accelerate the derivation and verification of an underneath common intent—i.e., ascertain or derive a new classification or subject, and not just classification into an existing subject or classification. Unsupervised learning software systems are also used for association rules mining to discover relationships between features from content data.

The system can incorporate an interactive content software service that utilizes one or more supervised or unsupervised software processing techniques to perform a subject classification analysis to generate subject data. Suitable software processing techniques can include, without limitation, LSA, PLSA, and LDA. Latent Semantic Analysis software processing techniques generally process a corpus of alphanumeric text files, or documents, to ascertain statistical co-occurrences of words that appear together, which then give insights into the subjects of those words and documents. The interactive content software service can utilize software processing techniques that include Non-Matrix Factorization, Correlated Topic Model (“CTM”), and K-Means or other types of clustering.

Neural networks may be trained using training set content data that comprise sample tokens, phrases, sentences, paragraphs, or documents for which desired subjects, content sources, interrogatories, or sentiment values are known. A labeling analysis may be performed on the training set content data to annotate the data with known subject labels (e.g., topics discussed during a shared experience also referred to herein as topic identifications), interrogatory labels (e.g., questions asked during a shared experience also referred to herein as interrogatory identifications), content source labels (e.g., identifications of participants to a shared experience), segment labels (e.g., opening, issue identification, or another segment), or sentiment labels, thereby generating annotated training set content data. For example, a person can utilize a labeling software application to review training set content data to identify and tag or “annotate” various parts of speech, subjects, questions, content sources, and sentiments.

The training set content data is fed to neural networks to identify subjects, content sources, or sentiments and the corresponding probabilities. For example, the analysis might identify that particular text represents a question with a 35% probability. If the annotations indicate the text is, in fact, a question, the error rate is 65% or the difference between the calculated probability and the known certainty. Then parameters to the neural network are adjusted (i.e., constants and formulas that implement the nodes and connections between node), to increase the probability from 35% to ensure the neural network produces more accurate results, thereby reducing the error rate. The process is run iteratively on different sets of training set content data to continue to increase the accuracy of the neural network.

The content data is first pre-processes using a reduction analysis to create reduced content data. The reduction analysis first performs a qualification operation that removes unqualified content data that does not meaningfully contribute to the subject classification analysis. The qualification operation removes certain content data according to criteria defined by a provider. For instance, the qualification analysis can determine whether content data files are “empty” and contain no recorded linguistic expressions between a provider agent and a user and designate such empty files as not suitable for use in a subject classification analysis. As another example, the qualification analysis can designate files below a certain size or having a shared experience duration below a given threshold (e.g., less than one minute) as also being unsuitable for use in an analysis, such as subject identification, sentiment analysis, or segmentation.

The reduction analysis can also perform a contraction operation to remove contraction and punctuations from the content data. Contraction and punctuation include removing or replacing abbreviated words or phrases that can cause inaccuracies in a subject classification analysis. Examples include removing or replacing the abbreviations “min” for minute, “u” for you, and “wanna” for “want to,” as well as apparent misspellings, such as “mssed” for the word missed. In some embodiments, the contraction can be replaced according to a standard library of known abbreviations, such as replacing the acronym “brb” with the phrase “be right back.” The contraction operation can also remove or replace contractions, such as replacing “we're” with “we are.”

The reduction analysis can also streamline the content data by performing one or more of the following operations, including: (i) tokenization to transform the content data into a collection of words or key phrases having punctuation and capitalization removed; (ii) stop word removal where short, common words or phrases such as “the” or “is” are removed; (iii) lemmatization where words are transformed into a base form, like changing third person words to first person and changing past tense words to present tense; (iv) stemming to reduce words to a root form, such as changing plural to singular; and (v) hyponymy and hypernym replacement where certain words are replaced with words having a similar meaning so as to reduce the variation of words within the content data.

Following a reduction analysis, the reduced content data is vectorized to map the alphanumeric text into a vector or matrix form—an operation that is also known as embedding. The content data files are converted to a series of machine encoded communication elements that make up the vectors or matrices (referred to herein as vectors as a shorthand even where matrices can be used). Machine encoded communication elements, also referred to as “communication elements” or sometimes “words,” can be words, phrases, symbols (e.g., an emoji, logo, etc.), numbers, or other elements of that make up a written or transcribed communication.

One approach to vectorizing content data includes applying “bag-of-words” modeling. The bag-of-words approach counts the number of times a particular word appears in content data to convert the words into a numerical value. The bag-of-words model can include parameters, such as setting a threshold on the number of times a word must appear to be included in the vectors.

Another technique for vectorization includes the Word2Vec method. The Word2Vec method employs skip-grams or a continuous bag of words (“CBOW”) and reconstructs the linguistic context of words by considering both the order of words in history as well as the predicted order of words. Shallow neural networks that have an input layer, an output layer, and a projection layer to iterate over a corpus of text to learn the association between the machine encoded communication elements. The method assumes that neighboring words in a text have semantic similarities with each other, and semantically similar machine encoded communication elements are mapped to geometrically close embedding vectors. Semantic similarity is measured using the cosine similarity metric. Cosine similarity is equal to the cosine of an angle where the angle is measured between the vector representation of text (e.g., sentences, phrases, or documents). If the cosine angle is one, it means that the words are overlapping. If the cosine angle is a right angle, the machine encoded communication elements hold no contextual similarity and are independent of each other.

Techniques to encode the content communication elements may, in part, determine how often communication elements appear together. Communication elements are often individual words but can also be groups of words like phrases, speech patterns, tone, cadence, or other characteristics of text. Determining the adjacent pairing of communication elements can be achieved by creating a co-occurrence matrix with the value of each member of the matrix counting how frequently one communication element coincides with another, either just before or just after it. That is, the words or communication elements form the row and column labels of a matrix, and a numeric value appears in matrix elements that correspond to a row and column label for communication elements that appear adjacent in the content data.

As an alternative to counting communication elements (e.g., words) in a corpus of content data and turning it into a co-occurrence matrix, another software processing technique may be used where a communication element in the content data corpus predicts the next communication element. Looking through a corpus, counts may be generated for adjacent communication elements, and the counts are converted from frequencies into probabilities (i.e., using n-gram predictions with Kneser-Ney smoothing) using a simple neural network. Suitable neural network architectures for such purpose include a skip-gram architecture. The neural network may be trained by feeding through a large corpus of content data, and embedded middle layers in the neural network are adjusted to best predict the next word.

The predictive processing creates weight matrices that densely carry contextual, and hence semantic, information from the selected corpus of content data. Pre-trained, contextualized content data embedding can have high dimensionality. To reduce the dimensionality, a uniform manifold approximation and projection algorithm (“UMAP”) can be applied to reduce dimensionality while maintaining essential information.

Prior to conducting a subject analysis to ascertain subject identifications in the content data (i.e., topics or subjects addressed in the content data) or interaction driver identifications in the content data (i.e., reasons why the customer initiated the interaction with the provider, such as the reason underlying a support request), the system can perform a concentration analysis on the content data. The concentration analysis concentrates, or increases the density of, the content data by identifying and retaining communication elements that have significant weight in the subject analysis and discarding or ignoring communication elements that have relativity little weight.

In one embodiment, the concentration analysis includes executing a term frequency-inverse document frequency (“tf-idf”) software processing technique to determine the frequency or corresponding weight quantifier for communication elements with the content data. The weight quantifiers are compared against a pre-determined weight threshold to generate concentrated content data that is made up of communication elements having weight quantifiers above the weight threshold.

Vectorization can be better understood with reference to the following simplified example. A corpus of machine encoded communication elements might include the following where each sentence is a row in a matrix: [I, forgot, my, account, password ∥ The, account, is, locked ∥ Please, reset, my, password, and, account]. Each machine encoded communication element can then be replaced by its frequency, such as: [1, 1, 2, 3, 2 ∥ 1, 3, 1, 1 ∥ 1, 1, 2, 2, 1, 3]. Here, the highest frequency is three, so each frequency value is divided by 3 to yield: [0.33, 0.33, 0.66, 1, 0.66 ∥0.33, 1, 0.33, 0.33 ∥0.33, 0.33, 0.66, 0.66, 0.33, 1].

In other examples, the vectorization creates a “sparse matrix” where each sentence, or row of the matrix, includes a frequency value for all distinct machine encoded communication elements within the corpus of content data. Where a communication element does not appear in a sentence, the frequency of the communication element is set to zero. Continuing with the foregoing example, the distinct communication elements include [I, forgot, my, account, password, the, is, locked, please, reset, and]. Each sentence is represented as follows: [1, 1, 1, 1, 1, 0, 0, 0, 0, 0, 0 ∥ 0, 0, 0, 1, 0, 1, 1, 1, 0, 0, 0 ∥ 1, 1, 2, 2, 1, 3 ∥ 0, 1, 1, 1, 0, 0, 0, 1, 1, 1].

Techniques to encode the context of words, or machine encoded communication elements, determine how often machine encoded communication elements appear together. Determining the adjacent pairing of machine encoded communication elements can be achieved by creating a co-occurrence matrix with the value of each member of the matrix counting how often one machine encoded communication element coincides with another, either just before or just after it. That is, the words or machine encoded communication elements form the row and column labels of a matrix, and a numeric value appears in matrix elements that correspond to a row and column label for communication elements that appear adjacent in the content data.

The concentrated content data is processed using a subject classification analysis to determine subject identifications (i.e., topics) addressed within the content data. The subject classification analysis can specifically identify one or more interaction driver identifications that are the reason why a user initiated a shared experience or support service request. An interaction driver identification can be determined by, for example, first determining the subject identifications having the highest weight quantifiers (e.g., frequencies or probabilities) and comparing such subject identifications against a database of known interaction driver identifications.

In one embodiment, the subject classification analysis is performed on the content data using a LDA analysis to identify subject data that includes one or more subject identifications (e.g., topics addressed in the underlying content data). Performing the LDA analysis on the reduced content data may include transforming the content data into an array of text data representing key words or phrases that represent a subject (e.g., a bag-of-words array) and determining the one or more subjects through analysis of the array. Each cell in the array can represent the probability that given text data relates to a subject. A subject is then represented by a specified number of words or phrases having the highest probabilities (i.e., the words with the five highest probabilities), or the subject is represented by text data having probabilities above a predetermined subject probability threshold.

Clustering software processing techniques include K-means clustering, which is an unsupervised processing technique that does not utilized labeled content data. Clusters are defined by “K” number of centroids where each centroid is a point that represents the center of a cluster. The K-means processing technique run in an iterative fashion where each centroid is initially placed randomly in the vector space of the dataset, and the centroid moves to the center of the points that is closest to the centroid. In each new iteration, the distance between each centroid and the points are recalculated, and the centroid moves again to the center of the closest points. The processing completes when the position or the groups no longer change or when the distance in which the centroids change does not surpass a pre-defined threshold.

The clustering analysis yields a group of words or communication elements associated with each cluster, which can be referred to as subject vectors. Subjects may each include one or more subject vectors where each subject vector includes one or more identified communication elements (i.e., keywords, phrases, symbols, etc.) within the content data as well as a frequency of the one or more communication elements within the content data. The interactive content software service can be configured to perform an additional concentration analysis following the clustering analysis that selects a pre-defined number of communication elements from each cluster to generate a descriptor set, such as the five or ten words having the highest weights in terms of frequency of appearance (or in terms of the probability that the words or phrases represent the true subject when neural networking architecture is used). In one embodiment, the descriptor sets were analyzed to determine if the reasons driving a customer support request were identified by the descriptor set subject identifications.

The software model may be evaluated according to three categories, including a “good match” where the support request reason(s) are identified by the top words in the subject vector (i.e., the words with the highest weight or frequency), a “moderate” match where the support request reason(s) are identified by the second tier of words in the subject vector (i.e., words six to ten), and a “poor” match where, for instance, the top words in a subject vector do not match or identify the reasons the support request was initiated.

Alternatively, instead of selecting a pre-determined number of communication elements, post-clustering concentration analysis can analyze the subject vectors to identify communication elements that are included in several subject vectors having a weight quantifier (e.g., a frequency) below a specified weight threshold level that are then removed from the subject vectors. In this manner, the subject vectors are refined to exclude content data less likely to be related to a given subject. To reduce an effect of spam, the subject vectors may be analyzed, such that if one subject vector is determined to include communication elements that are rarely used in other subject vectors, then the communication elements are marked as having a poor subject correlation and is removed from the subject vector.

In another embodiment, the concentration analysis is performed on unclassified content data by mapping the communication elements within the content data to integer values. The content data is thus turned into a bag-of-words that includes integer values and the number of times the integers occur in content data. The bag-of-words is turned into a unit vector, where all the occurrences are normalized to the overall length. The unit vector may be compared to other subject vectors produced from an analysis of content data by taking the dot product of the two-unit vectors. All the dot products for all vectors in a given subject are added together to provide a weighting quantifier or score for the given subject identification, which is taken as subject weighting data. A similar analysis can be performed on vectors created through other processing, such as K-means clustering or techniques that generate vectors where each word in the vector is replaced with a probability that the word represents a subject identification or request driver data.

To illustrate generating subject weighting data, for any given subject there may be numerous subject vectors. Assume that for most of subject vectors, the dot product will be close to zero—even if the given content data addresses the subject at issue. Since there are some subjects with numerous subject vectors, there may be numerous small dot products that are added together to provide a significant score. Put another way, the particular subject is addressed consistently throughout a document, several documents, sessions of the content data, and the recurrence of the carries significant weight.

In another embodiment, a predetermined threshold may be applied where any dot product that has a value less than the threshold is ignored and only stronger dot products above the threshold are summed for the score. In another embodiment, this threshold may be empirically verified against a training data set to provide a more accurate subject analysis.

In another example, a number of subject identifications may be substantially different, with some subjects having orders of magnitude fewer subject vectors than do other subjects. The weight scoring might significantly favor relatively unimportant subjects that occur frequently in the content data. To address this problem, a linear scaling on the dot product scoring based on the number of subject vectors may be applied. The result provides a correction to the score so that important but less common subjects are weighed more heavily.

Once all scores are calculated for all subjects, then subjects may be sorted, and the most probable subjects are returned. The resulting output provides an array of subjects and strengths. In another embodiment, hashes may be used to store the subject vectors to provide a simple lookup of text data (e.g., words and phrases) and strengths. The one or more subject vectors can be represented by hashes of words and strengths, or alternatively an ordered byte stream (e.g., an ordered byte stream of 4-byte integers, etc.) with another array of strengths (e.g., 4-byte floating-point strengths, etc.).

The interactive content software service can also use term frequency-inverse document frequency software processing techniques to vectorize the content data and generating weighting data that weight words or particular subjects. The tf-idf is represented by a statistical value that increases proportionally to the number of times a word appears in the content data. This frequency is offset by the number of separate content data instances that contain the word, which adjusts for the fact that some words appear more frequently in general across multiple shared experiences or content data files. The result is a weight in favor of words or terms more likely to be important within the content data, which in turn can be used to weigh some subjects more heavily in importance than others. To illustrate with a simplified example, the tf-idf might indicate that the term “password” carries significant weight within content data. To the extent any of the subjects identified by a natural language processing analysis include the term “password,” that subject can be assigned more weight by the interactive content software service.

The content data can be visualized and subject to a reduction into two-dimensional data using a UMAP to generate a cluster graph visualizing a plurality of clusters. The interactive content software service feeds the two-dimensional data into a DBSCAN and identify a center of each cluster of the plurality of clusters. The process may, using the two dimensional data from the UMAP and the center of each cluster from the DBSCAN, apply a KNN to identify data points closest to the center of each cluster and shade each of the data points to graphically identify each cluster of the plurality of clusters. The processor may illustrate a graph on the display representative of the data points that are shaded following application of the KNN.

The system can also incorporate Part of Speech (“POS”) tagging software code that assigns words a part of speech depending upon the neighboring words, such as tagging words as a noun, pronoun, verb, adverb, adjective, conjunction, preposition, or other relevant parts of speech. The interactive content software service can utilize the POS tagged words to help identify questions and subjects according to pre-defined rules, such as recognizing that the word “what” followed by a verb is also more likely to be a question than the word “what” followed by a preposition or pronoun (e.g., “What is this?” versus “What he wants is an answer.”).

POS tagging in conjunction with Named Entity Recognition (“NER”) software processing techniques can be used by the interactive content software service to identify various content sources within the content data. NER techniques are utilized to classify a given word into a category, such as a person, product, organization, or location. Using POS and NER techniques to process the content data allow the system to identify particular words and text as a noun and as representing a person participating in the discussion (i.e., a content source). Recognizing participants in content data is also called diarization and is discussed more fully below.

### Large Language Models

Natural language processing can be implemented by an LLM, which is a sophisticated artificial intelligence model that is configured specifically for natural language processing tasks. Large language models are designed to understand and generate human-like text based on the patterns and structures that the LLM learns from processing substantial volumes of training data.

Large language models are implemented with a deep learning architecture called a transformer. Transformers consist of multiple layers of self-attention mechanisms that allow a LLM to weigh the importance of different words or tokens in a sequence and capture the relationships between them. The attention mechanism allows LLM to effectively process and generate text with contextually relevant and coherent patterns. By assigning different weights to different words, LLMs can effectively focus on the most relevant information, which facilitates accurate and contextually appropriate content generation.

Large language models learn by predicting the next word in a given context using an unsupervised learning process. Through repetition and exposure to training data, the LLM develops a proficiency for grammar, semantics, and the knowledge contained in the training data. During a pre-training phase, training data is ingested by an LLM and tokenized to break the training data down into smaller units called tokens. Tokens can be words, subwords, or characters. Tokenization allows an LLM to process and understand text at a granular level. The LLM learns to predict the next token in a sequence, given the preceding tokens.

After pre-training, a LLM can be fine tuned and applied to a wide range of applications that entail performing specific tasks, such as sentiment analysis, diarization, a chat bot, virtual assistant, or a content generation system. Fine-tuning involves providing the LLM with task-specific labeled data, so the LLM learns intricacies of a particular task.

Once the LLM is trained and fine-tuned, it can be used for inference. Inference involves utilizing the LLM to generate text or perform specific language-related tasks. During inference, LLMs may employ a beam search technique to generate the most likely sequence of tokens. Beam search is an algorithm that explores several possible paths in the sequence generation process while keeping track of the most likely candidates based on a scoring mechanism. This approach helps generate more coherent and high-quality text outputs.

There are various types of LLMs, including, without limitation: (i) autoregressive language models; (ii) encoder-decoder models; (iii) transformer-based models; (iv) trained and fine-tuned models; and (v) hybrid models. Autoregressive models generate text by predicting the next word given the preceding words in a sequence. Encoder-decoder models are commonly used for machine translation, summarization, and question-answering tasks. Encoder-decoder models consist of two main components: (i) an encoder for processing input sequences; and (ii) a decoder that generates the output sequence. A transformer LLM is a type of encoder-decoder architecture.

Hybrid LLMs combine the strengths of different architectures. For example, some LLMs may incorporate both transformer-based architectures and recurrent neural networks. RNNs are commonly used for sequential data processing and can be integrated into a LLM to capture sequential dependencies in addition to the self-attention mechanisms of transformers.

### Content Segmentation

Content segmentation involves breaking down interactive content data into smaller sections based on criteria such as duration, specific topics or subject identifications discussed, or sentiment. The segments of content data are tagged according to subject identifications, sentiment, or a discrete set of pre-defined labels. Segmentation facilitates analysis of content data and enhances tracking and analysis of interactive communication sessions. Optionally, the segmented content data can be enhanced with metadata, such as participant identifications, a duration, or contextual information.

Conventional techniques for segmentation based on structure of the content data, such as lines between text, segment titles and headings, line breaks, indentations, or combinations of such features. The segments can also be identified using a categorizer that can be, for example, a PLSA neural network model trained on a set of segment categories, such as identifying chapters, headings, subheadings, paragraphs, lines of text, or individual words. In one embodiment the categorizer is trained to detect the beginning of each section, for example, by classifying each group of machine encoded communication elements or lines as being a segment identification or not (i.e., words or symbols denoting a segment of the content data). Identifying the structure of content data can rely on an analysis of font sizes or machine encoded communication element positioning. In one example embodiment content data parameters such as character size and spacing between characters, or words and lines are used to represent document physical layout.

Two techniques for segmentation include geometric segmentation and logical segmentation. According to geometric segmentation, an interactive content data file is split into text and non-text based on its geometric structure. Geometric segmentation can be used to identify encoded components that use shapes, symbols, and the like, such as images, symbols, logos, or the like within content data that might be used to denote various headings, subheadings, or sections. A logical segmentation is based on its logical labels such as “call start,” “call stop,” “opening,” “resolution,” or other logical components of the content data that represents a shared experience between an user and a provider agent. Logical segmentation is a process of splitting digital text into words, sentences, paragraphs, topics or meaningful sections.

In one example embodiment, the system can be configured to parse content data into segments that include, but that are not limited to: (i) an opening or greeting segment; (ii) information gathering; (iii) issue identification; (iv) problem description; (v) issue clarification; (vi) cause identification; (vii) solution determination; (viii) solution description; (ix) solution verification; and (x) closing. Those of skill in the art will recognize that the foregoing segments are provided as examples, and more or less segments of varying types, purpose, topics, and attributes can be used with the present system. Table 1 below includes a list and description of additional example segments that can be analyzed by the system. The number and type of segments to be identified is customizable and can be applied to varying sets of content data depending on, for instance, an enterprise line of business or client requirements.

TABLE 1

| Segment | Description |
|---|---|
| Acknowledge | The agent recognizes and confirms receipt of the customer inquiry. The |
| customer inquiry | agent acknowledges the customer's message, expresses gratitude and |
| | assures the customer that the inquiry is being addressed. |
| Clarify issue | The agent seeks additional information and details from the customer to |
| | ensure a clear and accurate understanding of the problem, the customer's |
| | concern, or the interaction driver (i.e., the reason the customer contacted |
| | the enterprise). The agent should ask specific questions, actively listen to |
| | the customer's responses and confirming details to eliminate any |
| | misunderstanding. |
| Complaint | The agent follows the established process and/or guidelines for |
| handling | effectively managing and resolving customer complaints. The agent |
| procedures | must actively listen, document complaints, and take appropriate actions |
| | to address issues. Complaints may be escalated to supervisors or |
| | transferred to specialized agents. |
| Customer | The agent confirms customer identity and key account or profile details to |
| information | verify the communication participant is an authorized customer. The agent |
| verification | asks specific security questions or requests identification information to |
| | authenticate identity and access customer records in a secure way. |
| Solution | The agent explains the proposed resolution or course of action to the |
| description | customer in a clear and understandable manner. The agent has provided |
| | the necessary details and instructions about how the issue will be resolved |
| | or what steps the customer needs to take. |
| Determine | The agent finds the appropriate resolution or course of action to address the |
| solution | customer issue, concern or reason for contact. The agent applies client |
| | policies and procedures and uses problem solving skills to identify the best |
| | possible solution for the customer. |
| Explain next steps | The agent provides a clear and concise explanation to the customer about |
| | the actions that will be taken in response to the customer inquiry or request. |
| | This segment involves outlining the process or course of action to be |
| | followed to address the issue, provide assistance or fulfill their request. |
| Explain purpose | The agent provides a concise and clear explanation to the called party about |
| of call | the reason for initiating the call. This step involves briefly describing the |
| | purpose, objective or topic of the call to ensure transparency and set the |
| | right expectations for the conversation. |
| Gather | The agent must collect relevant and essential details from the customer |
| information | during an interaction, which typically occurs at the start of the shared |
| | experience. This segment is crucial to understanding customer needs, |
| | concerns, and interaction driver. |
| Get issue | Involves actively listening to/reading the customer's description of the |
| | issue and recording the details of the problem or reason for contact. |
| Identify cause | Determine the underlying reason or root cause of the customer's issue or |
| | concern. This includes analyzing relevant information and using problem |
| | solving skills to get to the core of the problem. |
| Product/Service | The agent provides clear and concise information to the customer about the |
| explanation | features, benefits and usage of product or service, educates the customer on |
| | the capabilities of the products or services, and answers any questions or |
| | concerns the customer might have. The goal is to ensure the customer has |
| | a comprehensive understanding of the product or service. |
| Request additional | The agent asks customer for further details or clarification needed to |
| information | address the customer inquiry effectively. The agent seeks specific |
| (optional) | information that may be missing from the initial customer contact or that |
| | requires further elaboration. |
| Verify solution | Confirm that the determined resolution or course of action effectively |
| | addresses the customer's issue, concern, or interaction driver. The agent |
| | should explain the solution to the customer and seek customer agreement. |

The present system can utilize a variety of techniques to segment content data. Segmentation may utilize word embeddings to identify segments based on the coherence of the relationships between words. Word embedding convert content data (e.g., words, phrases, or a conversation) into numeric vectors where portions of content that have a similar meaning will have similar vector representations. Word embeddings can be obtained using language modeling and feature learning techniques where words or phrases from the vocabulary are mapped to vectors of real numbers.

One segmentation technique is a machine learning approach (i.e., a supervised approach) that includes manually tagging content data and using the tagged content data as training data to iteratively train a neural network that is deployed and used to automatically process and label content data. One type of machine learning technique is extractive summarization, which involves extracting key sentences from the text and using the key sentences to tag content data with pre-defined topics. Another approach, known as abstractive summarization, employs neural-network based summarization models, such as sequence-to-sequence models or transformer models, to generate concise summaries that can be used to train a neural network to predict tags for content data.

The system can be configured to rely on neural networks trained with annotated data that identify divided sections. The system can include separate software modules for line and section classification. The line classification software module itself includes a features extractor and line classifier module. The features extractor takes layout information and text as input. Based on heuristics, the feature extractor software module extracts features from layout information and text. Features include text length, the number of noun phrases, font size, higher line space, bold, italics, colon, and number sequence at the beginning of a line. The line classification module implements multiple classifiers using techniques such as support vector machines, decision tree, Naive Bayes, and Recurrent Neural Networks.

Supervised techniques can be used to determine whether each sentence within content data is a boundary sentence between segments or not. In one example embodiment, a bidirectional encoder representations from transformers (“BERT”) model is used to vectorize content data using self-supervised learning. The vectorized content data (i.e., embeddings) are passed to a bi-directional LSTM or a Transformer before calculating the SoftMax. Utilizing a bi-directional LSTM enables the system to look both forward and backward in a sentence before rendering a prediction about whether the sentence represents a boundary.

The outputs of can be segment data identifications and standard machine encoded communication element characters. The segment data identifications may be top-level categorization segment or a sub-segment. The segment classifier module of the segment classification sub unit takes section segment data identifications as input and classifies them as top-level, sub-segments or a top-level segment identification using RNN. The segment classification software module also has a Segment Boundary Detector that detects the boundary of a segment using different level of segment headers and regular text. It generates divided segment and finds relationship among top-level, segments and sub-segments. It also generates an index from an interactive content data file based on the relationship among different levels of segment.

Unsupervised approaches to segmentation include lexical cohesion, topic modeling, and similarity measurements. TextTiling is a lexical cohesion approach for segmentation that efficiently divides long text into coherent topical sections. TextTiling utilizes local lexical cohesion and identifies abrupt shifts in the thematic structure of a text, which are indicative of topic boundaries. By employing statistical techniques such as tokenization, similarity measurement, and smoothing, the TextTiling technique extracts informative features from the text and clusters them into distinct sections, allowing for better understanding and organization of large bodies of content data.

Segmentation can also be performed using software analysis techniques that evaluate equivalence between portions of content data (i.e., similarity measurements), such as Recall Oriented Understudy for Gisting Evaluation (“Rouge”) and Bilingual Evaluation Understudy (“Bleu”). Both Rouge and Bleu software analysis techniques utilize n-gram co-occurrence statistic ranging from 0 to 1. A metric value of “1” denotes that content data is exactly the same, and a metric value of “0” denotes there are no similarities in the content data. The “Rouge-N” technique determines the number of matching n-grams (i.e., groups of words) between two instances of content data, such as comparing two content data files, two sentences, or another component of segmented content data. Rouge techniques determine metrics that include precision, recall, and a F-1 score of matching n-grams.

In yet other embodiments, segmentation is performed using LLMs that operate on content data to predict probabilities for subject identifications or segment labels for each unit of linguistic expression, such as a statement, question, or phrase. Linguistic expression units with similar subject identifications or labels are grouped as a segment. The enterprise pre-defines a desired shared experience flow structure by specifying the segments to be identified. The flow structure can vary for every campaign depending on client requirements or line of business.

The shared experience flow structure is given as context to a pre-trained LLM as part of an instruction prompt. The instruction prompt to a LLM includes components such as: (i) an instruction—the specific task that the LLM should perform; (ii) context—external information or additional context that can steer the LLM to better responses; (iii) input data—the input or question to which a response is required; and (iv) an output indicator that defines the type or format of the output. In addition to segments, the LLMs can be trained and instructed to detect other structures within content data, such as detecting specific sentiment (e.g., a customer or agent being rude) or detecting content data representing specific tasks, such as promoting the sales of products specified by an enterprise customer. The number, type, and attributes of the detected segments can be customized according to enterprise customer requirements, quality assurance requirements, or training objectives.

### Communication Content Diarization

As part of analyzing interactive communication content, the system performs diarization operations that identify the content sources, or participants, in an interactive communication session. The participants generally include an agent and an end user but can also include any number of human or virtual participants, such as an interactive voice response (“IVR”) output. Diarization first processes acoustic data to determine the number of content sources and the content data associated with each content source before processing linguistic features of the content data to identify the content sources.

The content data is separated into distinct linguistic expression units where each unit corresponds to a particular participant. The system detects changes in participant identity and groups together units that belong to the same content source. The system can utilize linguistic features, such as detecting particular phrases or words, to identify content source, or use acoustic features alone or in combination with linguistic features.

The content data can be preprocessed using NLP operations such as a reduction analysis, tokenization, stop word removal, lemmatization, stemming, and hyponymy and hypernym replacement. Where the content data is stored in an audio format, preprocessing can include noise reduction, volume normalization, and the removal of non-speech segments (e.g., silence or background noise). The audio signal is then transformed into a sequence of feature vectors that represent acoustical properties. Common feature extraction techniques include Mel-frequency cepstral coefficients (“MFCCs”), spectrograms, or Mel-spectrograms, which capture time-varying characteristics of a speech signal.

The preprocessed audio signal is divided into smaller, non-overlapping units, each representing a potential region of linguistic expression. These units are identified using techniques such as voice activity detection (“VAD”), which detects regions of linguistic expression by distinguishing between speech and non-speech components based on signal characteristics such as energy, pitch, and spectral features. Alternative approaches include using deep learning-based classifiers to detect speech boundaries with higher precision.

Once the speech units are identified, participant embedding vectors are generated for each unit. A participant embedding is a fixed-dimensional representation of the participants vocal characteristics or speech characteristics, typically produced by a neural network trained on large datasets of labeled content data. The embedding vector captures the unique vocal traits or speech characteristics of the participant, such as tone, pitch, speaking style, or particular words or phrases used.

The participant embeddings are then clustered to group similar linguistic expression units based on participant identity. Clustering techniques, such as agglomerative hierarchical clustering, k-means, Gaussian mixture models (“GMM”) or Hidden Markov Models (“HMM”), are used to identify clusters corresponding to individual participants. Clustering algorithms exploit the similarity in participant embeddings to associate linguistic expression units with the correct participant.

After clustering, the system can assign participant labels to each cluster and detect the boundaries of individual participant turns. This involves determining when one participant stops and another begins. Participant turn detection can be based on temporal transitions between units and leveraging the sequence of clusters to identify shifts in participant identity. Techniques may include hidden Markov models or RNNs that model the sequential nature of participant transitions to ensure that boundaries are detected with high precision. LSTM neural network architecture can be used for participant boundary detection using acoustic features alone or in combination with linguistic content.

In the context of a call center or customer service environment, participant expression patterns can be more efficiently extracted from linguistic content than in other environments. Agents and end users often exhibits repetitive patterns of speech from session to session and the participants may be known in advance. For instance, agents may read from a script thereby exhibiting common linguistic expression patterns, and the system can capture participant identifying information prior to commencement of a shared experience. LSTM networks find particular applicability in a call center or customer service settings and are used to label words or phrases according to a particular participant.

Additional post-processing steps can be performed to improve the results. This may involve smoothing participant labels across units, eliminating misclassifications, and applying temporal constraints to ensure that the final participant unit aligns with natural speech patterns. The final output consists of a list of participant labels and their corresponding time intervals, indicating when each participant is active in the audio signal.

In instances where audio signals are being interpreted from audio files, video files, continual audio inputs (i.e., via a microphone), the system may apply binary time-frequency masks to separate signals from multiple sources by using a binary matrix to indicate which portions of a representation should be turned on or off. A binary mask includes a matrix of binary values that correspond to sources such that it is multiplied with a spectrogram to include or exclude portions of the audio. The binary time-frequency mask for each participant or audio source is obtained using clustering that assigns the number “1” to all time-frequency bins corresponding to the respective participant and assigning the number “0” to the remaining time-frequency bins. Inverse short time Fourier transform (“STFT”) may convert the obtained separated signals into a time domain for multiple downstream applications.

Speech waveforms may be synthesized from the masked clusters where each waveform corresponds to a different source of the audio. Further, the speech waveforms may be combined to generate a mixed speech signal by stitching together the speech waveforms corresponding to the different sources. Advantageously, this process can be used to remove certain voices or background conversations from a recording where there are multiple sources of audio.

Synthesizing speech waveforms from a cluster of numbers is not a process that can be practically performed in the human mind. By combining speech waveforms to generate a mixed speech signal by stitching together speech waveforms corresponding to different sources and excluding the sources that are undesired as either being undesired voices or background conversations. Advantageously, this can be used to isolate a desired source of audio as part of computer-based separation techniques to distinguish audio from different users. This can help the system accurately interpret the most relevant information in order to perform further analysis on the speech of the desired source of the audio.

While acoustic diarization techniques described above provide the structural who and when,” the system can also use one or more LLMs to perform a secondary, semantic layer of analysis known as speaker role identification. In a two-step architecture, the diarized audio is first transcribed using ASR. The LLM then processes the resulting transcript to analyze the linguistic context, conversational intent, and pragmatic markers of each speaker.

By evaluating the communication flow, such as identifying which participant provides technical instructions versus which participant is requesting assistance or product information—the system transitions from generic labels to functional roles. This allows the system to identify participants as an enterprise agent, customer, or even a virtual participant such as an IVR system or automated voice bot based on semantic content. Acoustic models may demonstrate limited accuracy in detecting high-quality synthetic speech from human voices, but a LLM can identify virtual participants by, for instance, adherence to scripts, repetitive syntax, and restricted vocabulary. By cross-referencing the temporal data from the initial diarization step with the semantic insights from the LLM, the system achieves a more granular understanding of the composition of an interactive communication session. A hybrid approach ensures content data is more accurately labeled according to the participant to provide higher quality data for downstream analytics such as sentiment analysis and agent evaluation, as described below.

### Data Flow and Processing Pipeline

The system includes a DataLake to facilitate regular retrieval, ingestion, and processing of content data from interactive communications, such as transcripts of audio and text-based customer interactions. The content data is then subject to diarization and segmentation, as described above. The DataLake is a storage repository that is designed to store a large amount of data in its native, raw format. The DataLake is designed to scale cost-effectively and is suitable for handling massive and diverse datasets. The data typically comes from multiple diverse sources and can include structured data (like relational tables), semi-structured data (like JSON, XML, or logs), and unstructured data (like images, audio, or video). Thus, the DataLake allows storage of data in its original, untransformed state, deferring transformation until the data is needed, which is function called schema-on-read. This contrasts with a data warehouse, which enforces structure and applies transformations as data is ingested, known as schema-on-write.

The DataLake enhances the system ability to implement production-ready, automated, continuous, native integrations with external, third party systems, such as when an enterprise is required to integrate with a client systems as part of rendering customer support services. The DataLake is specially adapted to continuously transfer the raw, native content data and metadata so that the content data can be used by the present systems and methods.

The native integration results in short deployment times and minimal technical dependencies on a client system without additional transformation layers. The DataLake can be configured for regular ingestion of native content data that is immediately compatible with the present system, such as the ingestion of recorded call data, chat data, and associated metadata every 3-4 hours. The DataLake can also be configured for scoped access so that only particular types and sources of data can be accessed for security purposes.

In some cases, the third party client system may use a cloud-based platform-as-a-service (“PaaS”) that may be the same or similar to a PaaS used by the current system. In cases where a client system does not use a cloud-based computing system, the present system can be configured to nonetheless facilitate native content data transfers by supporting file-based ingestion techniques built on top of a cloud storage system, such as secure API-based ingestion for programmatic content data file transfer and secure file transfer protocol (“SFTP”) for scheduled or batch uploads.

The present system supports architecture patterns for integration to a client system and ingestion of content data that include: (i) cloud-native integration using replication or a high-speed online data transfer service to transfer data to the DataLake (e.g., AWS® Connect or Amazon® S3 Replication to the DataLake); (ii) direct export using bulk export service; (iii) hybrid or on-premise methods where local storage is transferred to the DataLake; and (iv) legacy or internal file copy to the DataLake. For on-premise ingestion, a high-speed data transfer service software application can be deployed within a client network that uses dedicated data transfer protocols to transfer large amounts of data between on-premises storage, or other cloud providers, and the dedicated landing zone and DataLake. The specialized high-speed data transfer service software application can be compatible with Network File System shares, Server Message Block shares, Hadoop Distributed File Systems, self-managed object storage, and object storage in other cloud environments.

All integration methods enforce strict data segregation, traceability, and security controls. Regardless of the ingestion path, once data enters the DataLake it follows a unified processing flow and becomes available consistently across the present system.

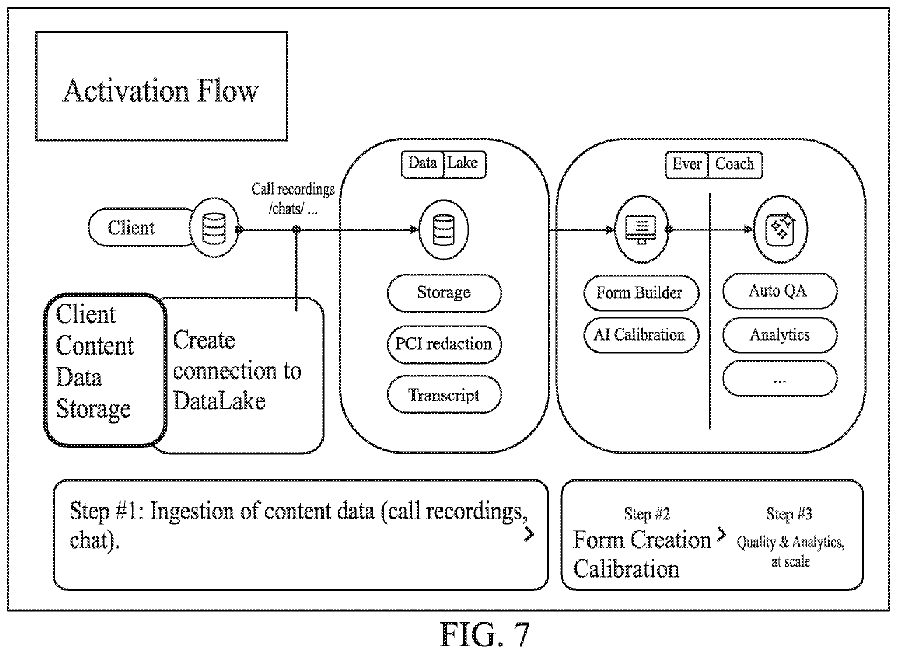

The activation flow for system integration between the present system and a client system is depicted in FIG. 7. Content data stored to a client system is transferred through one of the ingestion techniques described above. The content data can include call recordings, alphanumeric chat or email data, and corresponding metadata. The content data can be raw content data in native format and is transferred, encrypted, and processed within the DataLake. Language is detected within audio files and then transcribed using speech recognition technology for the detected language, with speaker diarization to identify and label the different speakers in the audio.

As discussed below, the DataLake is configured to redact any PII data and/or PCI data from transcripts of content data and to delete audio files containing PII data and/or PCI data. Speaker-diarized content data is then retrieved and analyzed by an AutoQA module using a trained, instructed LLM approach to analyze the calls with guidance from custom quality forms. Call recordings can be streamed to allow authorized users within the system to listen to them, with calls containing PCI data excluded from streaming.

The data flow proceeds such that redacted transcripts are first ingested and stored in the DataLake. A scheduler service retrieves the transcripts and directs them to an evaluation pipeline, where AI models generate scores, insights, and coaching recommendations. These outputs are then stored in a database, from which they can be securely accessed by authorized users. A caching layer is used for user profiles and permissions, reducing repeated calls to authorization services and minimizing the exposure of sensitive data. The user interface only presents insights derived to users—at no point are raw transcripts or customer identifiers displayed.

Client systems may include a telephony system that is assigned a dedicated landing zone. The landing zone is a pre-configured, secure, and scalable environment that serves as the foundation for deploying workloads in a cloud such as Amazon® web service (“AWS”) or Microsoft® Azure®. The landing zone provides a standardized framework—including network architecture, identity management, and security guardrails that are essential for governance and compliance, allowing organizations to securely migrate or build applications. Once data enters the landing zone, it is automatically tagged with metadata and transcribed removing sensitive data.

### Data Transfer Security and Storage

All data transferred between client systems and the DataLake utilizes secure HTTPS connections with Transport Layer Security (“TLS”) or Secure Sockets Layer (“SSL”) protocols, safeguarding data as it moves between the client's domain and the DataLake. Content data in transit within the system's domain is secured via private networking and encrypted using TLS/SSL protocols alongside private networking to prevent unauthorized access and data exposure. Files may be encrypted using Pretty Good Privacy (“PGP”) to ensure data integrity and confidentiality during transit. PGP is an encryption program that provides cryptographic privacy and authentication for data communication, including texts, emails, files, and directories.

Upon arrival, encrypted content data files are stored in cloud storage that uses encryption (such as AES-256) for data at rest. Content data files are stored in the DataLake for a configurable retention period, with a default retention period of ninety days. If custom retention policies are required, they can be configured based on client security policies and regulatory needs. Content data retention is configurable, and special consideration is given to content data to support playback functionality such that decrypted audio files are retained for as long as they are required to be accessible based on client agreement.

### Security Architecture and Access Controls

The system may be accessible only within the network in which it is deployed. Access to the system is limited to users natively on the network or those who access it remotely through secured VPN connections. Access is controlled using role-based permissions, Single Sign-On (“SSO”), and Multifactor Authentication (“MFA”). Enterprise agents and other users are provisioned automatically via enterprise human resource information system (“HRIS”) integrations.

Role-based access control may be applied such that only enterprise users associated with a certain client account or project identification can access data for that account. Read-only view of call transcripts may also be provided to authorized users including coaches, quality analysts, and operations managers. Project identifications may be granted access through a managed process, and once a project is enabled, the system retrieves the enterprise users associated with that project identification based on mappings defined in the HRIS system through a directory service. If enterprise users such as agents join, leave, or transfer across clients, campaigns, or lines of business, their system access is automatically updated shortly after their human resources (“HR”) profile changes.

Retention of personal data such as personal identifying data or payment data is limited to data contained within content data and stored for a limited period of 90 days by default, or the data retention period can be customized according to clients data retention policies. Personal data is not used for any additional or secondary processing purposes.

All data may be segregated by client account, hosted in a secure private cloud, and protected by technical and organizational security measures. Coaching recommendations and other analysis elements are generated contextually without any data leaving the enterprise's infrastructure. All LLM inference and logic execution happens within a secure and monitored environment. The LLM provider operates within a private provider tenant, and no data is used to train the LLM model. Data encryption is implemented using TLS (e.g., 1.2 and 1.3) for encryption in transit and at rest.

### AI Model Governance

The system utilizes LLMs provided through a private enterprise tenant, ensuring data isolation and security. Machine learning engineers are responsible for prompt engineering to mitigate the risks of model hallucinations, and an AI QA team periodically tests to confirm the system behaves as expected. Human intervention throughout the AI processing cycle may include a calibration phase to ensure the AI system is performing as expected on a specific data set for a specific account. No production data or personal information is used to train the AI models. Periodic tests of the AI system may be conducted to confirm correct model behavior.

### Communication Monitoring and Agent Training Modules

The present system automates the process for monitoring interactive communications and generating agent training modules. The system relies on AI technology and LLMs that allow an enterprise to enhance agent skill, optimize shared experiences, and achieve more consistent and higher-quality service standards. The system is configured to analyze large volumes of interactive communications such that the system can be efficiently and expediently scaled to handle larger volumes of shared experiences without committing the substantial degree of system and personnel resources required by conventional monitoring and training techniques. Moreover, unlike human performed monitoring and training, which is subject to bias and inconsistency, the present system generates objective, data-driven feedback based on the same criteria for every agent.

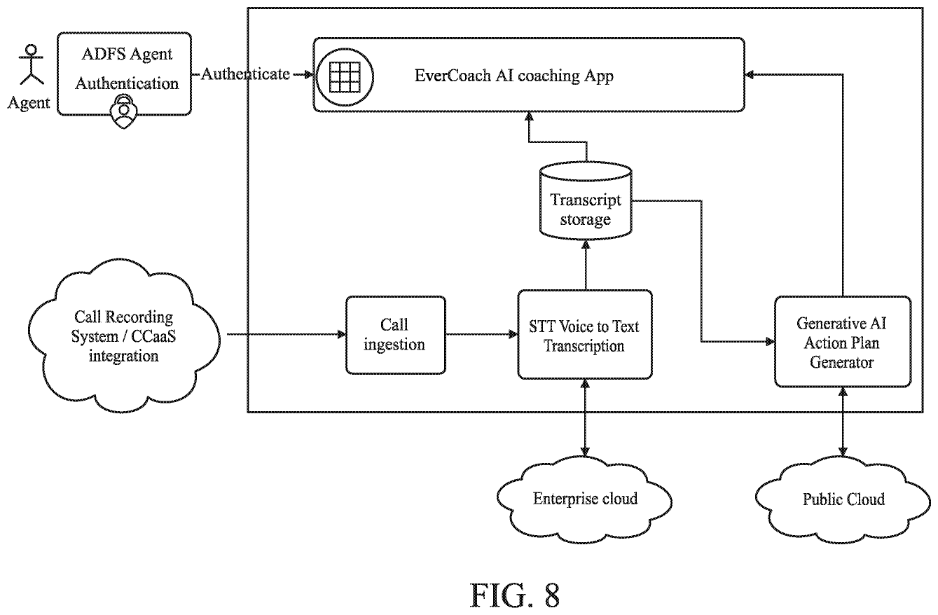

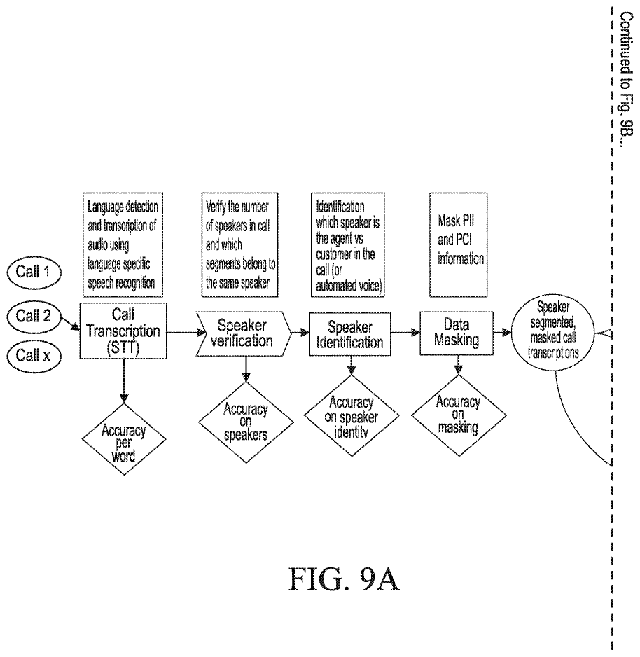

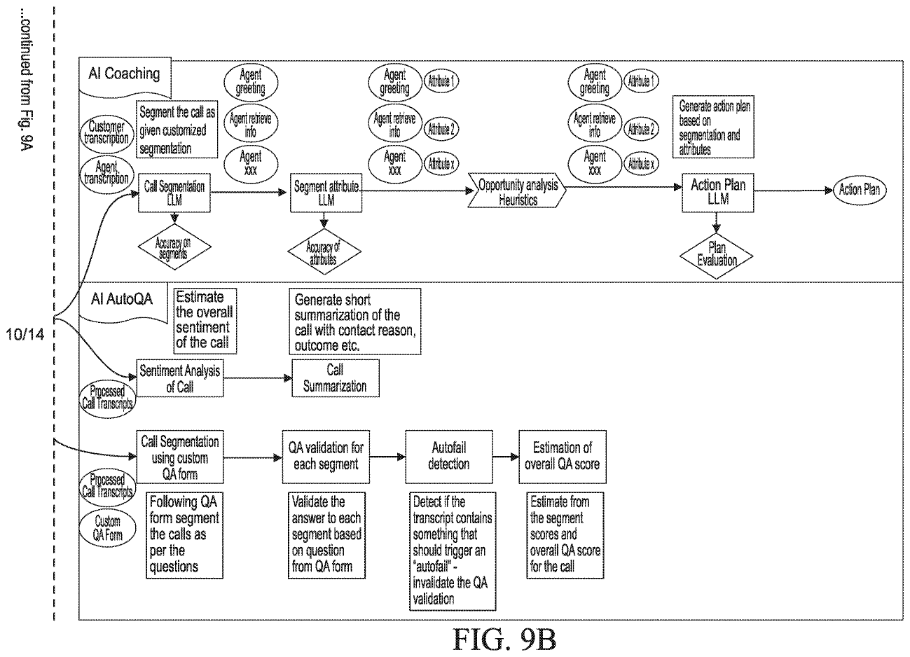

An example system for communication monitoring and generating agent training modules is shown in FIG. 8, and an example process flow is depicted in FIG. 9. The various steps executed by the system are performed stepwise where data and results from a prior step serve as context for the next step. Each step can be performed by a separate LLM call or an entirely separate LLM. The results from a prior step can serve as part of the input prompt to a LLM that executes the next step.

Shared experiences are conducted by enterprise agents that use an agent computing device to authenticate to a provider system through, for example, an Active Directory Federation Services software service. Once authenticated, the agent engages in shared experiences where the agent interactively communicates with end users (i.e., customers) using software applications and platforms that include, but that are not limited to, an email software application, an instant chat message software application, SMS message, multi-media message service (“MMS”), social media messaging, a video conferencing software application, or a separate telephone device or a virtual telephone interface software application.

The system activates a digital recorder and captures the interactive communications between agent computing devices and end users and stores the interactive communications as interactive content data. In the embodiment depicted in the attached figures, interactive communications are recorded using a cloud-based, contact center as a service (“CCaaS”) software platform integrated with a call ingestion software module or Application Programming Interface (“API”) implemented by the enterprise system. The interactive content data, along with metadata, is stored to a database on the provider system or to a remote storage location integrated with the CCaaS platform.

Interactive content data from shared experiences is captured continuously for all shared experiences or may be captured according to predefined campaign parameters. For instance, certain customer shared experiences can be captured and stored for regulatory compliance purposes, captured at periodic intervals, or interactive content data can be gathered for customer shared experiences involving an agent that is known to be exceptionally efficient or who is known to deviate from client-required processes. The interactive content data can be initially stored to a buffer location before being moved to a permanent content storage database according to predetermined campaign parameters established by an enterprise.

Interactive content data campaigns can accommodate a wide variety of possible campaign parameters, such as capturing content data according to certain enterprise clients, lines of business, or for certain client-required processes. To illustrate, if a client requires agents to utilize a specific trouble shooting process for customer technical support requests relating to a specific product, then an interactive content data campaign can be established that stores shared experiences involving technical service requests for that particular customer and product. Interactive content data campaign parameters may additionally be established to gather content data for certain named agents or for all agents with specific experience parameters, such as all agents with less than a year of experience. The campaign parameters are also useful for setting limitations on the sample size of the recorded interactive content data, such as specifying a set number of shared experiences to be stored over a specific data range.

The interactive content data can be captured along with metadata that includes, but is not limited to: (i) time and date data indicating when a shared experience began or ended; (ii) duration data indicating the length of a shared experience; (iii) an endpoint identifier such as a user principal name (“UPN”) used to identify the agent using an agent computing device, which can be, for instance, a username, employee number, or other identification entered by the agent when logging into the agent computing device, the Active Director Federated Service (“ADFS”), or a software application used for a shared experience; (iv) an endpoint identification, such as a device identification that identifies the particular computing device used by an agent, which can be a hardware serial number, a network identification number, or any other identifier unique to the agent computing device; (v) a client account identification and a line of business identification that can be used by an enterprise to identify a client or industry being served by the activities of the agent and end user; (vi) an agent role designation (i.e., junior agent, senior agent, supervisor, etc.); (vii) geographic location data for the agent; (viii) a site identifier if the enterprise agent is working from a given enterprise location or office; (ix) an “on-network” flag indicating whether the agent is working remotely or from within an enterprise location; (x) agent years of experience; (xi) data indicating prior training performed by an agent; and (xii) any other information that is useful for characterizing and analyzing a shared experience.

Interactive content data stored as video data or as an audio signal can be converted into an alphanumeric text format using automatic speech recognition (“ASR”) software applications and stored to transcript storage. The STT software application can be integrated with the enterprise system or run from a separate cloud environment. The system can use anonymization algorithms to sanitize the transcribed alphanumeric text data by removing or masking sensitive information such as personal identifying information (“PII”), payment card information, or bank account information.

Certain example embodiments are described with reference to performing various analyses on the transcribed content data, including diarization, segmentation, or creation of a training module. But those of skill in the art will appreciate that the system can perform such analyses on the interactive content data either in the audio signal, video data, or transcribed format.

Turning to FIGS. 9A-9B, following an optional transcription operation using ASR software, the system performs diarization to identify the participants to a shared experience. The diarization operations divide up the audio signals or text content data into according to participant identification. The diarization can be performed using a trained neural network or a rule-based software module that identifies participants based on linguistic or acoustic features.

Following diarization, the interactive content data is segmented into pre-defined segments that include, without limitation, an opening, a problem description, probing questions, explanations, solution discussions, and closing. Segmentation allows the system to analyze specific parts of the shared experience and assess an agent's actions and behavior in context. The segmentation can be implemented with machine-learning software, including deep learning or generative AI models such as a LLM.

The system evaluates an overall classification of a shared experience and separately evaluates each segment of the interactive content data according to various performance attributes selected by an enterprise as desired indicators of agent performance. Agent performance can be evaluated at predefined intervals using stored interactive content data, such as evaluating agent performance every one-hundred shared experiences, once per month, or another interval. The system can also evaluate agent performance in real time during live shared experiences to generate post-shared-experience improvement recommendations and quality evaluations.

Example performance attributes that are evaluated at each segment can include, but are not limited to: (i) Probing—whether an agent asks relevant questions to understand the end user's particular issue(s); (ii) Clarity and Structure—maintaining a clear and well-structured communication style during the customer interaction, including concisely and clearly expressing information in a logical sequence; (iii) Conversation Control—the ability of the agent to maintain control of the conversation to ensuring the shared experience is productive and focused; (iv) Explanation—how well the agent explains the solution, steps, product, or service to the end user in a clear, concise manner that addresses the end user's particular concerns; (v) Process Compliance—whether the agent adhered to established client processes or guidelines to ensure compliance and consistency, such as verifying a customer's identity, troubleshooting a technical issue with a product, issuing a return or refund, or performing sales activities; and (vi) Tool Usage—utilization of available tools and resources to enhance the efficiency and effectiveness of a shared experience, including using software applications, databases, knowledge bases, or other tools to access relevant end user information, product or service details, or solutions that address the end user's concern or inquiry.

Each segment of a shared experience is labeled to indicate whether particular attributes were present and fulfilled in each segment. In some embodiments, the content data representing the entire shared experience (i.e., all segments) is analyzed to evaluate certain attributes applicable to all segments, such as politeness, sentiment, and consistency. The content data for a shared experience can also be labeled according to these overall attributes. The labeled content data is used for opportunity analysis heuristics, which identifies parts of a shared experience that should be highlighted as “good” versus those eligible for potential improvement. For example, if a greeting phase was identified but deemed inappropriate, it would be flagged for improvement suggestions and potential actions to take as part of a training module or action plan.

Those of skill in the art will appreciate that other performance attributes can be used to evaluate the overall shared experience or individual segments, such as evaluating shared experience handle times (“AHT”), First Call Resolution (“FCR”), and Customer Satisfaction (“CSAT”). AHT refers to the overall duration of a shared experience or segment of a shared experience particularly as compared to shared experiences of a similar type. The FCR represents the proportion of shared experiences where a customer objective was satisfied during the first shared experience attempt (e.g., successful sale or technical support resolution on a first call). CSAT is an indicator of the customer's satisfaction with the overall shared experience considering the resolution, duration, or other factors. FCR and CSAT can be measure by, for instance, customer satisfaction surveys or data input by an agent following a shared experience as part of an after call wrap-up process where agents input data concerning a recent shared experience.

The performance attributes can be scored according to a scale selected by the enterprise, such as evaluating each attribute: (i) on a scale of 1 to 10; (ii) according to a letter grade such as A to F; (iii) according to certain descriptors such as “needs improvement,” “meets expectations,” or “exceeds expectations;” or (iv) any other suitable scoring schema used by the enterprise. The performance evaluation can be tailored to according to various agent attributes, such as applying criteria more strictly to experience agents than inexperienced agents or applying the criteria differently across various enterprise clients or lines of business. To illustrate, an agent with one month experience might receive an evaluation of “meets expectation” after asking two probing questions whereas an agent with ten years of experience receives a “needs improvement” for asking the same questions. As another example, a particular line of business or client might have a very simple process compliance criteria that evaluates only whether an agent asked the end user about a new product in which case the performance is graded for all agents on a binary scale such as “true” or “false.”

The segment performance evaluation can be conducted using one or more LLMs that analyze language used in each shared experience segment. The LLMs can be trained with templates of shared experiences or volumes of training data generated from historical data captured from prior shared experiences. The LLMs can be trained to evaluate nuances that permit more empathetic interactions with customers. Nuances that can be evaluated include, but are not limited to: (i) tone; (ii) sentiment describing the emotion exhibited by an agent or customer during a shared experience, such as agitation with a trouble shooting process that is taking an unusually long time or satisfaction with an issue that was expediently resolved; (iii) communication effectiveness at accurately conveying the intended concept; (iv) conversation control that ensures that the participants stayed on particular topics rather than changing topics frequently; (v) communication efficiency at conveying an intended concept in an appropriately short amount of time; (vi) behaviors characterizing the demeanor exhibited by the end user and the agent at given points in time during a shared experience, such as active listening, typing, providing feedback, interrupting the other speaker, repetitive use of phrases, overreliance on particular phrases or techniques, expressions of frustration, or a demonstration of confidence by an agent during a solution discussion segment; and (vii) other characteristics that represent the nuances of agent performance and the quality of a shared experience.

The nuanced attributes can be converted to labels that are stored a database on the enterprise system along with the agent performance attribute scoring (collectively “evaluation data”). The agent evaluation data is associated with each corresponding agent. The system evaluates agent performance repeatedly over time through multiple shared experiences to identify performance trends. The results of a current performance evaluation can be compared to evaluation data for prior evaluations to detect improvements or deterioration in performance over time as well as particular trends, such as an agent consistently receiving low scores for the “explanation” task during the solution discussion segment of shared experiences. Such trends are factored into training module generation to refine the modules based on changing performance trends.

The system uses stored evaluation data and other outputs of the segmentation and performance evaluation to generate a customized training module for a particular agent. The training module is a package of instructions, examples, reference materials, simulation data, or other data configured for execution and display by an agent computing device. The training module is generated to be easily understood, capable of being implemented through agent actions, and tailored to a particular agent's strengths and weaknesses. The system relies on generative AI software, such as a LLM, to create the training modules for transmission to, and execution by, an agent computing device.

An example training module can incorporate elements that include, but are not limited to: (i) clear instructions for improving overall agent performance and/or agent performance at a particular segment of a shared experience; (ii) excerpts to transcripts, audio data, or video data from specific shared experiences that illustrate how to implement improvement instructions; (iii) training exercises to improve questioning or probing skills, such as requiring an agent to listen to audio data from a shared experience and select a correct course of action from among multiple choices; (iv) instructions for implementing communication techniques to enhance conversation control; (v) behavioral suggestions to improve empathy, rapport-building, and conflict resolution; (vi) procedural updates to ensure better adherence to client protocols; (vii) links or user selectable inputs to display reference materials, such as enterprise or client procedures.

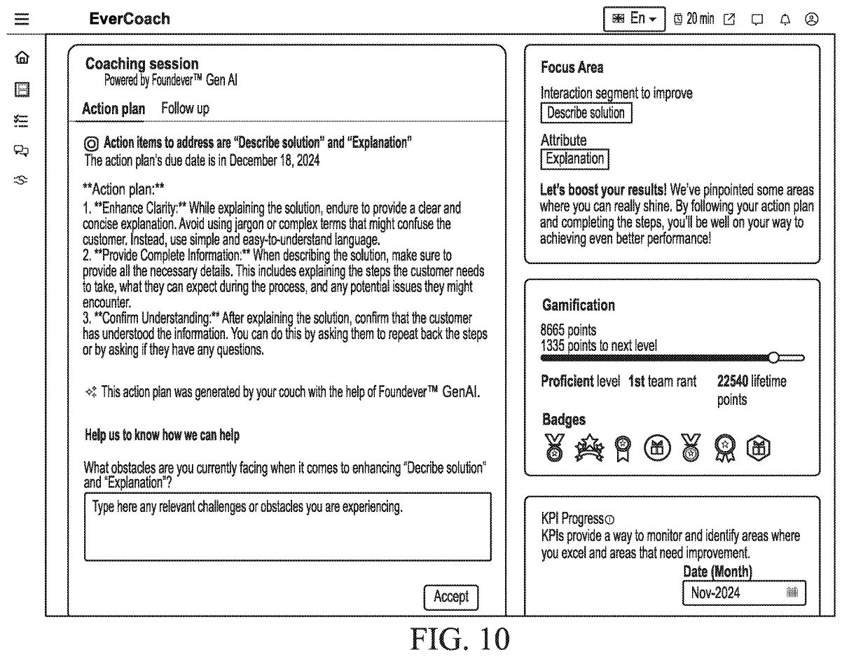

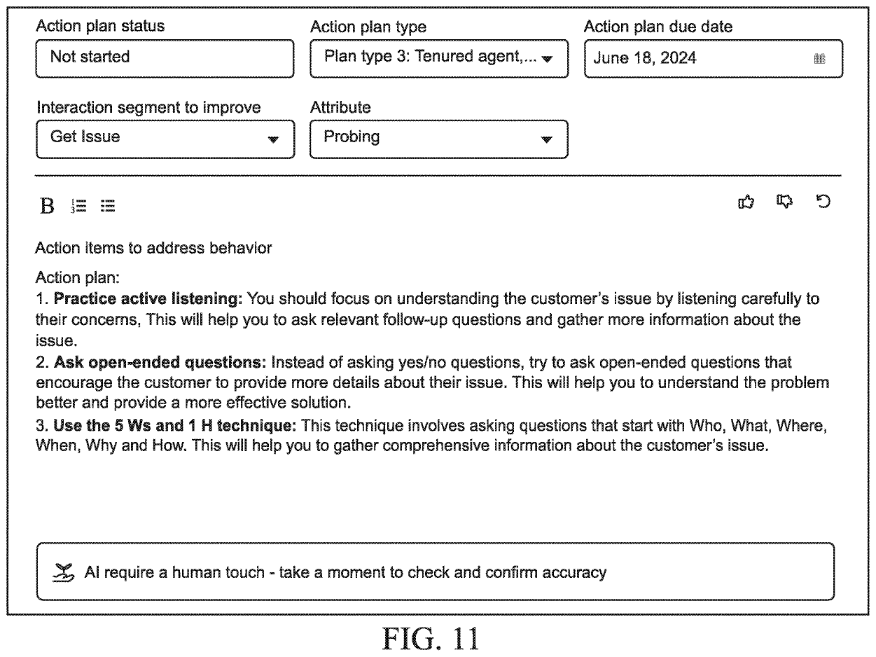

Example training modules are shown in FIGS. 10 and 11. The training modules can be displayed by an Internet browser software application running on an agent computing device. The example training module shown in FIG. 10 illustrates improvement instructions that include recommending that a particular agent use less jargon, describe in detail steps that an end user or customer must perform, and confirm that an end user understands the information provided by an agent. The training module also provides input on particular segments or attributes to be improved, such as the solution description segment and the explanation attribute.

The system is further configured to track execution of a training module over time, as illustrated in FIG. 11, where the training module display includes data fields for a training module status (e.g., “Not Started”) and due date. The training modules are specifically designed to include actionable instructions, and the system monitors whether such instructions are implemented by agents. The system can be configured to deliver training modules periodically at specified intervals or asynchronously if there is a particular need for monitoring and training. In some embodiments, the system includes one or more enterprise dashboard graphical user interfaces that are configured to display agent evaluation data, training modules, and training module status such that an enterprise has visibility into agent performance and training.

### Automated Quality Assurance System

As shown in FIG. 9B, in addition to the communication monitoring and agent training modules described above, the present system further includes an automated quality assurance (i.e., “AutoQA” or “AI AutoQA”) component that automates interactive communication analysis and produces objective, comprehensive evaluations, enhancing the precision of feedback and broadening the scope of evaluated interactions. The AutoQA module may share common initial processing steps with the AI coaching module described above, including content data ingestion, speech-to-text conversion, diarization, transcript processing, and data masking. However, the AutoQA module diverges to perform automated quality evaluation against customizable quality forms and to generate quality scores at a scale that is unattainable through manual review.

The AutoQA module equips operations teams with automatically generated QA assessments and custom coaching plans for each agent, based on agent tenure, trend analysis, and key performance indicator (“KPI”) results. The AutoQA module may enable users to analyze interactive communications at scale using generative AI for faster and more consistent reviews, receive continuous suggestions to support agent improvement, spend less time scoring and more time supporting agents, identify strengths, address gaps, and track growth over time, and integrate impartial assessments of performance into up to one hundred percent of shared experiences.

The AutoQA component processes the content data to generate summarization data, which can include the interaction driver, an outcome of a shared experience, and the subjects or topics raised as part of a shared experience. The AutoQA component further includes an Autofail module that identifies content data indicating a failed shared experience that would not meet quality assurance thresholds, such as when an agent did not comply with protocol. The system can automatically generate training modules that are sent to an agent involved in failed shared experience, notify a supervising agent, or remove content data from the failed shared experiences from a larger corpus of content to avoid biasing analysis performed on the data.

### AutoQA Application Architecture

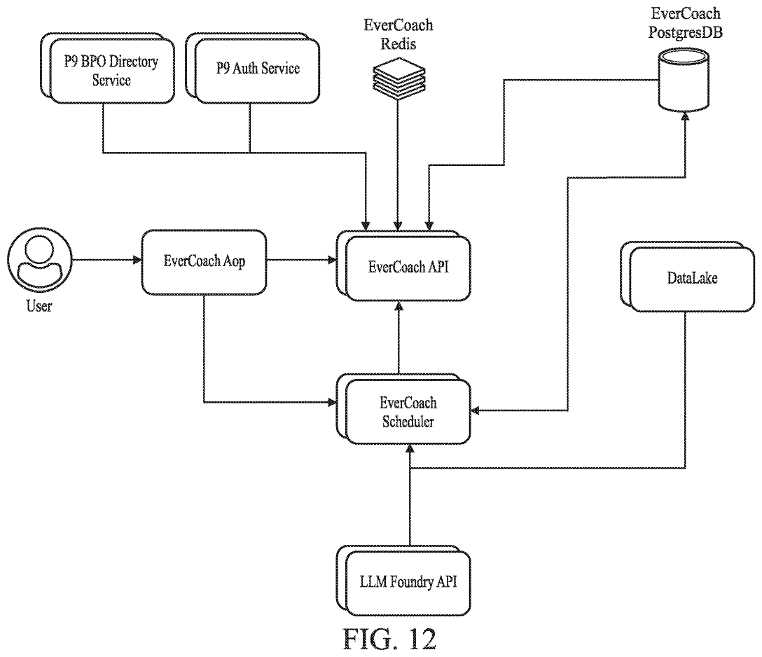

In FIG. 12, the AutoQA system architecture comprises multiple interconnected components. A front-end user interface may be implemented as a web application (e.g., “EverCoach Application”) hosted via a content delivery network and cloud storage, which serves as the primary interface for managing requests and displaying quality evaluation results. Data flows through a back-end application programming interface (“API”) service (e.g., “EverCoach API”) responsible for routing requests, ensuring authentication and authorization, and coordinating between various service components.

For authentication, the system may use an identity management service that authenticates users via an enterprise identity federation service (e.g., Keycloak®). For authorization, the system uses a combination of authentication and directory services that determine the data and accounts accessible to a given logged-in user (e.g., Planet9® Authentication service and Planet9® BPO Directory service). The architecture is completed with supporting components including a caching layer for securely storing user profiles (e.g., “Redis”), a relational database for application data (e.g., PostgreSQL or “Postgres”), and the DataLake for anonymized transcripts.

System components include: (i) a front-end application hosted via a content delivery network and cloud storage; (ii) a back-end API service hosted on container orchestration clusters that serves as the main backend for handling requests and managing service components; (iii) a scheduler service that manages daily pipelines for running evaluations for every project; (iv) the DataLake for storage of processed call transcripts; (v) an authentication service that handles granting and checking access for the application to clients, projects, and users; (vi) a directory service that handles organizational data such as clients, projects, employees, and the connections between them; (vii) a cache storage layer for storing user profiles and their permitted data access; (viii) a relational database that stores application data including evaluation forms and evaluation results; (ix) an identity management service that handles authentication to ensure only authorized users can access the system; and (x) a metrics and monitoring service for system observability.

### Custom Quality Forms and Evaluation Pipeline

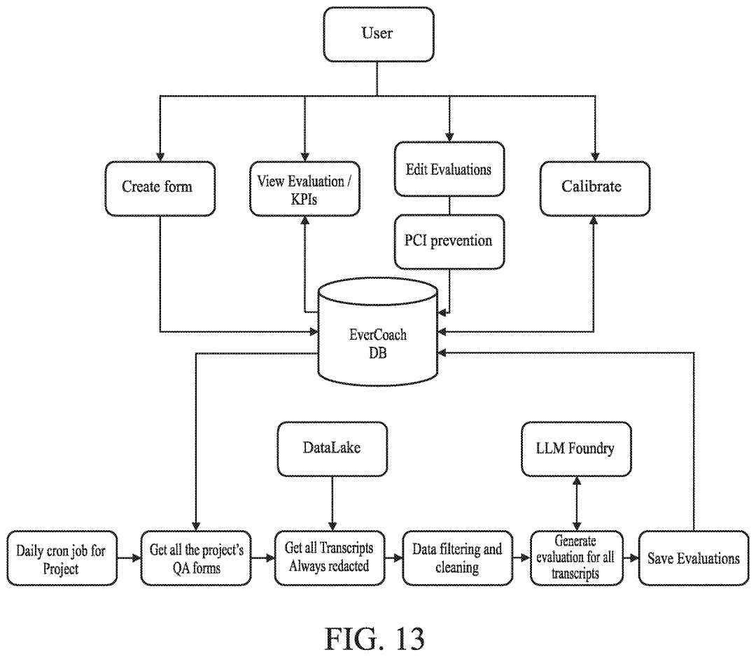

In FIG. 13, users may interact with the system primarily through four key actions: (i) creating new quality forms; (ii) viewing evaluations and KPIs; (iii) editing existing evaluations to correct AI outputs; and (iv) calibrating the AI. The quality forms are configured as a series of customizable language-based queries, such as, but not limited to: “Did the agent greet the caller with a friendly tone,” “Was the introduction clear and professional,” “Did the agent recite legally required disclaimers?” The queries can be answered with a “yes” or “no,” “true” or “false,” a positive or negative numeric score, a pre-selected discrete set of narrative descriptions, or letter grades, or another format suitable for objective, consistent evaluations. The answers can also be converted between data types and the query answers can be weighted. For example, a “yes” to question 1 can yield a score of 20 points, while a “yes” to question 2 can yield a score of 40 points reflecting a relative higher importance for question 2.

When a user creates a new quality form, all parameters are stored in the database, including the structure of the quality grid, individual questions, scoring rules, and descriptive elements that guide the AI pipeline. This context allows the AutoQA AI evaluation software service to interpret conditions accurately and generate relevant scoring. Once a form is published, the user can still refine and enhance the context provided to the AutoQA system. The AutoQA system utilizes a software service to analyze the content data and complete the customizable quality form.

A calibration process retrieves the stored parameters from the database and allows users to update them, ensuring that the AI continues to adapt to project-specific needs. The calibration phase ensures the AI system is performing as expected on a specific data set for a specific account, with human intervention throughout the AI processing cycle. In addition to calibration, users can manually edit the scoring of individual evaluations, thereby maintaining human oversight and control over all quality decisions.

The system may operate a scheduler that runs daily pipelines, depicted in FIG. 12. Each job is tied to a specific project identification. For each project identification, the job fetches all published quality forms from the application database via the API, determines the latest date from which evaluations can be found, and retrieves transcripts from that date onward from the DataLake. After collecting the forms and transcripts, the system runs the evaluation pipeline to generate new evaluations, which are then stored in the application database. The scheduler filters the data by removing duplicates and poor-quality transcripts, ensuring only clean inputs are processed.

### PCI and PII Compliance and Data Redaction

The system does not store, process, or transmit PCI data in any of its application components. To guarantee compliance and protect sensitive information such as credit card data, multiple safeguards are in place. At the DataLake ingestion layer, all PII data and PCI data is detected and redacted during transcription before being stored. When transcripts metadata, or other content data is retrieved for evaluation, any PII data and PCI data has already been redacted. As a result, no raw PII data or PCI data is ever exposed to the application. Additionally, audio files containing PII and PCI data are automatically deleted from the DataLake.

At the front-end user interface, during manual editing of evaluations, a PCI control mechanism prevents users from saving suspected PII and PCI data. If the system detects potential PII and PCI data, the user is prompted to delete or modify the content before continuing. Since this is the only pathway through which sensitive credit card content could enter the system from the front-end, this control ensures that the application remains fully secured against PII and PCI data risks. Together, these controls ensure that the system is fully PII and PCI data compliant, maintaining strict safeguards across data ingestion, storage, processing, and user interaction layers.

The system utilizes speech-to-text solutions in conjunction with regular expression pattern matching to perform real-time transcription of call recording inputs in volatile memory, during which cardholder data is identified and redacted. The system truncates personal identifying information and cardholder data when presented in either text or speech-to-text format. The system may receive PCI DSS certification (PCI DSS is a global information security standard designed to prevent fraud through increased control of credit card data), with cardholder data redaction enforced as part of the transcription and review process at the application layer to ensure that cardholder data is not processed, stored, or transmitted.

### Integration of AutoQA and Coaching Modules

The AutoQA module and the AI coaching module described in the preceding sections share a common initial process pipeline. In FIG. 9, both modules rely on the same data ingestion, speech-to-text conversion, diarization, and transcript processing infrastructure. The two modules diverge after the common processing steps, with the coaching module proceeding to performance trend analysis and training module generation, and the AutoQA module proceeding to quality form-based evaluation, scoring, and quality metric generation. The evaluation data generated by the AutoQA module can be used as an input to the coaching module, such that quality scores and identified deficiencies inform the generation of personalized training plans.

With reference to FIG. 9, in an integrated embodiment, the system executes the following pipeline: (i) call recordings are ingested from client telephony systems through native cloud integrations, direct storage integrations, or file-based ingestion; (ii) audio files are transcribed using language-specific speech recognition with speaker diarization; (iii) PCI data is redacted during transcription; (iv) transcribed content data undergoes segmentation, diarization, and sentiment analysis; (v) the AutoQA module evaluates the transcribed content data against custom quality forms to generate quality scores; (vi) the coaching module analyzes performance trends across multiple shared experiences; (vii) personalized training modules are generated based on both AutoQA evaluation results and performance trend analysis; and (viii) training modules are delivered to agent computing devices for execution and tracking.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A system for communication quality comprising a processor, a storage device storing data and executable code that, when executed, causes the processor to:
(a) capture interactive communications and store the interactive communications to the storage device as a content file;
(b) convert the content file to machine encoded communication elements;
(c) execute a diarization module that determines a source that generated each machine encoded communication element, wherein the source comprises an agent or an external user;
(d) parse each content file into a plurality of segments;
(e) generate an interactive communication evaluation by analyzing the machine encoded communication elements in each segment to detect the presence or absence of each attribute in an attribute set;
(f) generate a training module based on the interactive communication evaluation, wherein the training module comprises a set of executable instructions; and
(g) transmit the training module to an agent computing device, wherein (i) the agent computing device displays the customized training module on a display device integrated with an agent computing device, and (ii) the agent executes the set of executable instructions.

2. The system of claim 1, wherein each attribute in the attribute set is assigned a score.

3. The system of claim 1, wherein each attribute comprises one or more of probing, clarity and structure, interactive communication control, process compliance, or tool usage.

4. The system of claim 1, wherein attribute comprises one or more of a handle time, a first call resolution, and a satisfaction score.

5. The system of claim 1, wherein the step of generating an interactive communication evaluation is performed by a large language model.

6. The system of claim 5, wherein the large language model evaluates the machine encoded communication elements according to nuance attributes comprising tone, sentiment, communication efficacy, or interactive communication control.

7. The system of claim 1, wherein the training module further comprises audio data and visual data that simulates a shared experience.

8. The system of claim 1, wherein the training module further comprises a series of questions and selectable input functions displayed on the integrated display device.

9. The system of claim 1, further comprising an automated quality control software module comprising executable code that, when executed, cause the processor to evaluate the machine encoded content elements generated by the agent by applying a quality form, wherein (i) the quality form comprises a plurality of queries, and (ii) the automated quality control software module generates a response to each query.

10. The system of claim 1, wherein the system further comprises a plurality of integration architectures to capture an interactive content file, wherein the plurality of integration architectures comprises native cloud integration, direct cloud storage integration, and file-based ingestion.

11. A system for communication quality comprising a processor, a storage device storing data and executable code that, when executed, causes the processor to:
(a) activate a digital recorder that captures interactive communications and stores the interactive communications to the storage device as a content file;
(b) convert the content file to machine encoded communication elements;
(c) identify sources to the interactive communications, wherein (i) the sources comprise an agent, and (ii) the agent generated a set of machine encoded communication elements;
(d) analyze the machine encoded content elements generated by the agent to assess an agent performance based on defined attributes;
(e) generate a customized training module for the agent based on the agent performance, wherein the training module comprises a set of executable instructions; and
(f) transmit the training module to an agent computing device, wherein (i) the agent computing device displays the customized training module on a display device integrated with the agent computing device, and (ii) the agent executes the set of executable instructions.

12. The system of claim 11, further comprising an automated quality control software module comprising executable code that, when executed, cause the processor to evaluate the machine encoded content elements generated by the agent by applying a quality form, wherein (i) the quality form comprises a plurality of queries, and (ii) the automated quality control software module generates a response to each query.

13. The system of claim 12, wherein the automated quality control software module comprises a large language module.

14. The system of claim 12, wherein the quality form is customizable and generated by a system user inputting natural language data into a graphical user interface.

15. The system of claim 11, further comprising an automated quality control software module comprising executable code that, when executed, causes the processor to:
(a) generate a quality form comprising a grid of evaluation queries and executable scoring instructions for each evaluation query;
(b) evaluate the machine encoded content elements generated by the agent by running a large language model software application that implements the quality form and generates a quality score; and
(c) store the quality score to the storage device in a format that is accessible to a user through a graphical user interface.

16. A system for communication quality comprising a processor, a storage device storing data and executable code that, when executed, causes the processor to:
(a) interface with an external system comprising an interactive communication content file in a native format;
(b) ingest the interactive communication content file to a DataLake;
(c) convert the interactive communication content file to machine encoded communication elements;
(d) group machine encoded communication elements according to a source, wherein the source comprises an agent or an external user;
(e) parse each interactive communication content file into a plurality of segments that each comprise the machine encoded content elements;
(f) generate an interactive communication evaluation by analyzing the machine encoded communication elements in each segment according to an attribute set;
(g) generate a training module based on the interactive communication evaluation, wherein the training module comprises a set of executable instructions; and
(h) transmit the training module to an agent computing device, wherein the agent executes the set of executable instructions.

17. The system of claim 16 wherein the DataLake is configured to:
(a) detect PCI data and detect PII data in the interactive communication content file; and
(b) redact PCI data and redact PII data from the interactive communication content file.

18. The system of claim 16, wherein the operation of generating an interactive communication evaluation is performed by a large language model.

19. The system of claim 16, wherein the system further comprises a plurality of integration architectures for ingesting the interactive communication content file, wherein the plurality of integration architectures comprises native cloud integration, direct cloud storage integration, and file-based ingestion.

20. The system of claim 16, wherein executing the executable code further causes the processor to:
(a) impose role-based access control, wherein the agent can access the interactive communication evaluation only if the agent is assigned a given role; and
(b) segregate data by a client account.
